(19) United States
(12) Patent Application Publication
(10) Pub. No.: US 2023/0318094 A1
(43) Pub. Date: Oct. 5, 2023

(54) Battery Cell

(71) Applicant: APB Corporation, Tokyo (JP)

(72) Inventors: Hideaki Horie, Tokyo (JP); Yohji Kawasaki, Kyoto (JP); Yasuhiro Shindo, Kyoto (JP); Yusuke Nakashima, Kyoto (JP); Kaho Suzuki, Kyoto (JP); Yuya Tanaka, Kyoto (JP); Yuki Nekohashi, Kyoto (JP); Ryosuke Kusano, Kyoto (JP)

(21) Appl. No.: 18/040,674

(22) PCT Filed: Aug. 6, 2021
(86) PCT No.: PCT/JP2021/029397

§ 371 Date: Feb. 6, 2023

(30) Foreign Application Priority Data
Aug. 6, 2020 (JP) 2020-133822
Sep. 9, 2020 (JP) 2020-151373
Sep. 10, 2020 (JP) 2020-152210

(51) Int. Cl. H01M 50/105; H01M 50/342; H01M 10/0525; H01M 4/66; H01M 50/569

(52) U.S. Cl. CPC H01M 50/105; H01M 50/3425; H01M 10/0525; H01M 4/668; H01M 50/569

(57) ABSTRACT

A battery cell (1) has an electrode composition, a frame member (3) placed annularly so as to surround the electrode composition, and a positive electrode current collector and a negative electrode current collector for closing openings of the frame member (3) from both sides in the thickness direction. The frame member (3) has a fragile portion (9) for communicating inside and outside of the frame member (3) when the pressure inside the frame member increases above a certain level. The battery cell (1) in question allows increase in the pressure inside the frame member (3), thereby preventing damage.

### TECHNICAL FIELD

The present invention relates to a battery cell.

### BACKGROUND ART

A lithium-ion secondary battery has been widely used in recent years for various applications as a high-capacity, compact, and lightweight rechargeable battery, for example. A typical lithium-ion secondary battery consists of a plurality of laminated battery cells. The battery cell has, for example, an electrode composition consisting of a negative electrode composition layer and a negative electrode composition layer laminated via a separator, a frame member disposed annularly around the electrode composition to seal each electrode composition layer, and an electrode current collector that covers the frame member from both sides in the thickness direction to collect and extract current. The negative electrode composition layer and the negative electrode composition layer contain electrode active material particles.

### CITATION LIST

### Patent Literature

PTL1: Japanese Patent Laid-Open No. 2017-33937
PTL2: Japanese Patent Laid-Open No. 2017-79211
PTL 3: International Publication No. 2009/119075

### SUMMARY OF INVENTION

### Technical Problem

In a battery cell, the pressure inside the frame member may temporarily increase depending on the operating environment. For example, when discharged at a high current or overcharged, gas may be generated in the electrode composition, causing the pressure inside the frame member to rise. Such an increase in pressure could result in damage to the battery cell.

The present invention thus provides a battery cell that can prevent damage by suppressing the pressure rise inside the frame member.

### Solution to Problem

As a result of earnest examination based on the above findings, the inventors have conceived of a series of diligent examinations and have arrived at the various aspects of the present invention shown below.

A battery cell, comprising
an electrode composition containing electrode active material particles
a frame member placed annularly so as to surround the electrode composition; and
a base material for closing openings of the frame member from both sides in the thickness direction,
wherein the frame member has a pressure releasing portion for communicating inside and outside of the frame member when the pressure inside the frame member increases above a certain level.

### Advantageous Effects of Invention

According to the present invention, the inside and outside of the frame member are communicated with each other when the pressure inside the frame member increases above a certain level by the pressure releasing portion. Therefore, damage to the battery cell can be prevented.

### BRIEF DESCRIPTION OF DRAWINGS

FIG. 1 is a schematic diagram of an assembled battery in an aspect of the first embodiment.

FIG. 2 is a schematic diagram of the battery cell 1 in an aspect of the first embodiment.

FIG. 3 is a plan view of a frame member in an aspect of the first embodiment viewed from the thickness direction.

FIG. 4 is an explanatory view of the effect of the frame member in an aspect of the first embodiment viewed from the thickness direction.

FIG. 5 is an enlarged plan view of the main part of the frame member in a second aspect of the first embodiment viewed from the thickness direction.

FIG. 6 is an explanatory view of the effect of the frame member in a second aspect of the first embodiment.

FIG. 7 is an enlarged plan view of a main part of a frame member 303 viewed from the thickness direction in a third aspect of the first embodiment.

FIG. 8 is an explanatory view of the effect of the frame member in a third aspect of the first embodiment.

FIG. 9A is a schematic diagram showing a lithium-ion secondary battery in a first aspect according to the first embodiment.

FIG. 9B is a schematic diagram showing a lithium-ion secondary battery in a second aspect according to the first embodiment.

FIG. 10A is a schematic diagram showing a lithium-ion secondary battery in a first aspect according to the second embodiment.

FIG. 10B is a schematic diagram showing a lithium-ion secondary battery in a second aspect according to the second embodiment.

FIG. 10C is a schematic diagram showing the appearance of the single battery structure of a lithium-ion secondary battery in a first aspect according to the second embodiment.

FIG. 11 is a schematic diagram showing the single battery structure of the lithium-ion secondary battery in a second aspect according to the second embodiment that is disassembled by component.

FIG. 12 is a flow diagram showing the manufacturing process of a single battery structure according to the second aspect.

FIG. 13 is a flow diagram showing the recycling process of a single battery structure according to the second aspect.

FIG. 14 is a flow diagram showing the segregation process of a single battery structure according to the second aspect.

FIG. 15A is a schematic diagram showing peeling off of the negative electrode current collector of the single battery structure of the second aspect.

FIG. 15B is a flow diagram showing the recycling process of a single battery structure according to the second aspect.

FIG. 16 is a perspective view showing recycling of the negative electrode active material of the single battery structure of the second aspect.

FIG. 17 is a schematic diagram showing peeling off of the negative electrode current collector of the single battery structure of the second aspect.

FIG. 18 is a perspective view showing the recycling process of a single battery structure according to the second aspect.

FIG. 19 is a schematic cross sectional view showing a lithium-ion secondary battery in a second aspect according to the second embodiment.

FIG. 20A is a schematic diagram showing the appearance of the single battery structure of a lithium-ion secondary battery in a second aspect according to the second embodiment.

FIG. 20B is a schematic diagram showing the appearance of the single battery structure of a lithium-ion secondary battery in a second aspect according to the second embodiment.

FIG. 20C is a schematic diagram showing the appearance of the single battery structure of a lithium-ion secondary battery in a second aspect according to the second embodiment.

FIG. 21 is a schematic diagram showing the single battery structure of the lithium-ion secondary battery in a second aspect according to the second embodiment that is disassembled by component.

FIG. 22 is a schematic perspective view showing peeling off of the negative electrode current collector of the single battery structure of the second aspect.

FIG. 23 is a schematic perspective view showing peeling off of the negative electrode current collector of the single battery structure of the second aspect.

FIG. 24 is a perspective view of the single battery constituting a lithium-ion battery nodule in a third aspect according to the first embodiment.

FIG. 25A is a IIa-IIa cross sectional view of FIG. 24.

FIG. 25B is a IIb-IIb cross sectional view of FIG. 24.

FIG. 26 is a perspective view of the light emitting portion and the single battery light receiving portion constituting the lithium-ion battery module in a third aspect according to the first embodiment.

FIG. 27 is a schematic partially cutaway view of a lithium-ion battery module in a third aspect according to the first embodiment.

FIG. 28 is a block diagram showing the circuit configuration of the lithium-ion battery module in a third embodiment according to the first embodiment.

FIG. 29 is a schematic enlarged cross sectional view of a lithium-ion battery module in a third embodiment according to the first embodiment.

FIG. 30A is a schematic diagram showing an optical signal pattern when the voltage of the single battery in the third aspect varies.

FIG. 30B is a schematic diagram showing an optical signal pattern when the voltage of the single battery in the third aspect varies.

FIG. 30C is a schematic diagram showing an optical signal pattern when the voltage of the single battery in the third aspect varies.

FIG. 30D is a schematic diagram showing an optical signal pattern when the voltage of the single battery in the third aspect varies.

FIG. 30E is a schematic diagram showing an optical signal pattern when the voltage of the single battery in the third aspect varies.

FIG. 31 is a flowchart as to the control of the lithium-ion battery module in the third aspect according to the first embodiment.

FIG. 32 is a partially cutaway view schematically showing the lithium-ion battery module in the third aspect according to the second embodiment

FIG. 33 is a block diagram showing the circuit configuration of the lithium-ion battery module in the third embodiment according to the second embodiment.

FIG. 34 is a schematic enlarged cross sectional view of a lithium-ion battery module in the third aspect according to the second embodiment

### DESCRIPTION OF EMBODIMENTS

The various aspects of the present invention are described More specifically below with reference to the drawings.

[First aspect] First, a battery cell according to a first aspect will be described.

### First Embodiment

<Assembled Battery>

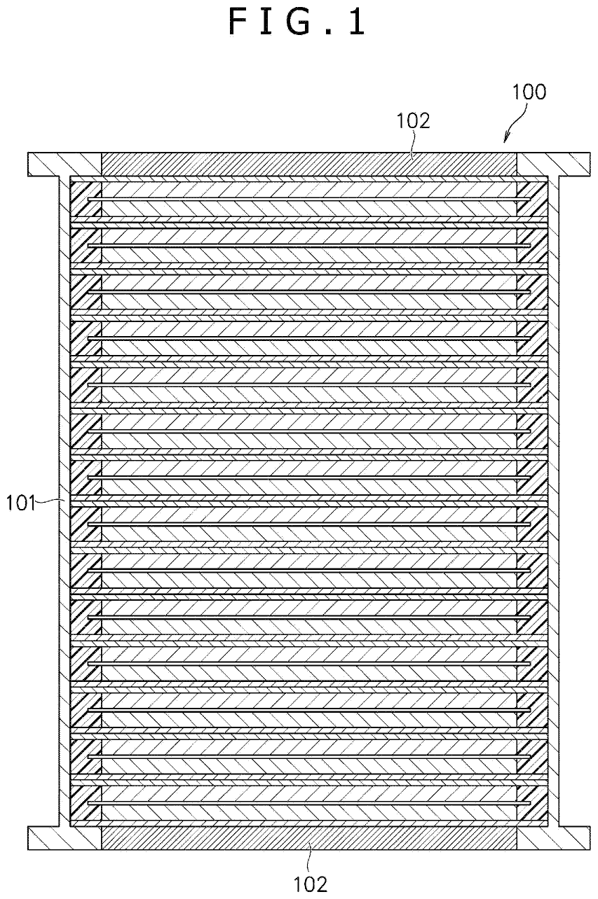

FIG. 1 is a schematic diagram of an assembled battery 100, which is a modularized by combining battery cells 1 according to the present invention.

The assembled battery 100 is a so-called lithium-ion secondary battery. As shown in FIG. 1, the assembled battery 100 is composed of a plurality of flat-plate battery cells 1 laminated in the thickness direction. The thickness direction of the battery cells 1 may be referred simply to as the thickness direction below.

The assembled battery 100 has an outer layer film 101 provided so as to cover the circumference of the laminated battery cells 1. The outer layer film 101 can be made of a flexible insulating material. However, it is not limited to this, but a laminate film may be used as the outer layer film 101, for example. As a laminate film, it is possible to preferably use a three-layered laminate film with a nylon film on the outside, aluminum foil in the center, and an adhesive layer such as modified polypropylene on the inside. The assembled battery 100 has current outlets 102 at both ends of the battery cell 1 in the laminating direction. A current is supplied to various electrical products via these current outlets 102.

<Battery Cell>

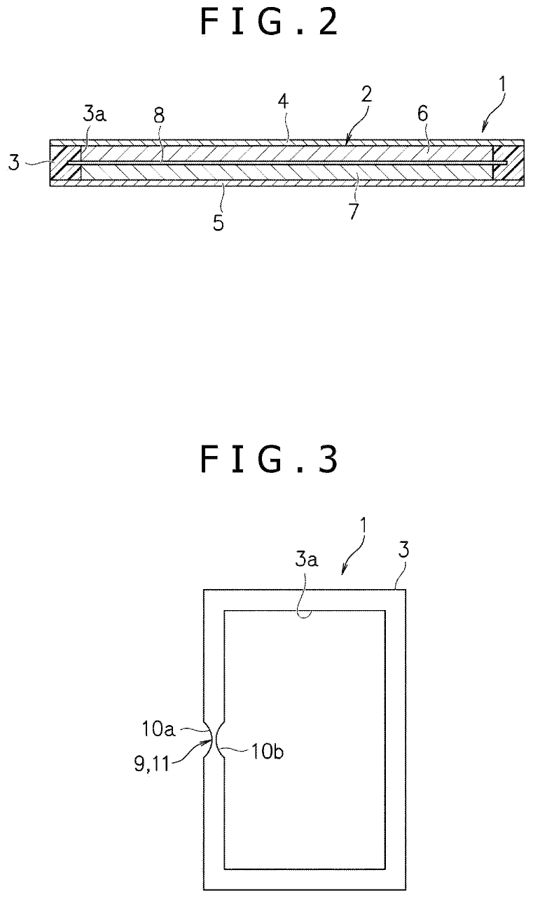

FIG. 2 is a schematic diagram of the battery cell 1.

As shown in FIG. 2, the battery cell 1 has an electrode composition 2, a frame member 3 disposed annularly so as to surround around the outer periphery of the electrode composition 2 except both surfaces in the thickness direction, a negative electrode current collector 4 and a negative electrode current collector 5 which close the openings 3a of the frame member 3 from both sides in the thickness direction. The battery cell 1 is formed in a rectangular shape, for example, viewed from the thickness direction.

The electrode composition 2 is composed of a negative electrode composition layer 6 containing negative electrode active material particles and a negative electrode composition layer 7 containing negative electrode active material particles, which are laminated via a separator 8. The negative electrode current collector 4 is disposed to cover the negative electrode composition layer 6, and the negative electrode current collector 5 is disposed to cover the negative electrode composition layer 7. Each of the electrode current collectors 4 and 5 can be used to obtain an electrode for a lithium-ion battery that collects and extracts a current from the battery cell 1.

The shape of each of the electrode current collectors 4 and 5 is not particularly limited, but preferably in the same external shape of the frame member 3 in plan view in the direction of thickness, or similar to the external shape of the frame member 3 and slightly smaller than the frame member.

Examples of material configuring each of the electrode current collectors 4 and 5 include metallic materials such as copper, aluminum, titanium, stainless steel, nickel, and alloys of these materials. Among these, copper is preferred from the viewpoints of light weight, corrosion resistance, and high conductivity. The negative electrode current collector may be a current collector made of calcined carbon, conductive polymer, conductive glass, etc., or a resin current collector made of conductive agent and resin.

The same conductive agents as those contained in the electrode compositions can be suitably used as the conductive agents that constitutes the resin current collectors for both the electrode current collectors 4 and 5. Example of resin constituting the resin current collector include polyethylene (PE), polypropylene (PP), polymethylpentene (PMP), and polycyclo-olefin (PCO) can be used as the resin comprising the resin current collector. PMP), polycyclo-olefin (PCO), polyethylene terephthalate (PET), polyethernitrile (PEN), polytetrafluoroethylene (PTFE), styrene-butadiene rubber (SBR), polyacrylonitrile (PAN), polymethyl acrylate (PMA), polymethyl methacrylate (PMMA), polyvinylidene fluoride (PVdF), epoxy resins, silicone resins, or mixtures of these resins. In terms of electrical stability, polyethylene (PE), polypropylene (PP), polymethylpentene (PMP), and polycyclo-olefin (PCO) are preferred, and polyethylene (PE), polypropylene (PP) and polymethylpentene (PMP) are more preferred.

When such a resin current collector is used, for example, as a resin current collector for a bipolar electrode, a negative electrode may be formed on one side of the resin current collector and a negative electrode on the other side to form a bipolar electrode.

Thus, the battery cell 1 consists of the negative electrode composition layer 6 and a negative electrode active material layer 72, the outer circumference of which is sealed with the frame member 3 to contain the electrolyte. An assembled battery 100 is configured by laminating such battery cells 1 with the orientation of each electrode current collector 5 aligned and connecting each battery cell 1 in series.

More specifically, the assembled battery 100 consists of a plurality of battery cells 1 laminated so that the negative electrode current collector 4 in one battery cell 1 and the negative electrode current collector 5 in another battery cell 1 adjacent to the battery cell 1 in the laminating direction are in contact with each other, and each of the battery cells 1 are connected in series. In this laminated structure, a current collector is formed by laminating the negative electrode current collector 4 and the negative electrode current collector 5. Such a laminated structure can also be described as a bipolar type electrode with a negative electrode on one side and a negative electrode on the other side of the current collector, and the bipolar type electrode is laminated with a separator.

As mentioned above, the assembled battery 100 includes a plurality of battery cells 1 each laminated and connected in series, and also includes a plurality of flat batteries (single battery units) laminated so that they are not electrically connected but are in physical contact with each other. When used as a resin current collector for bipolar electrodes with a negative electrode formed on one side of the current collector and a negative electrode on the other side, the assembled battery 100 may be constructed as a laminated body (bipolar battery) in which the negative electrode is formed on one side of the current collector (resin current collector for a bipolar electrode) and the negative electrode is formed on the other side to form a bipolar electrode, and the bipolar electrode is laminated with a separator.

The assembled battery 100 includes batteries that use solid materials as electrolytes (so-called all solid-state batteries) as well as batteries that use liquid materials as electrolytes. However, it is assumed that frame member 3 is used even when a solid material is used for the electrolyte.

Furthermore, the assembled battery 100 includes electrodes configured by applying a negative electrode active material or a negative electrode active material, etc. to the negative electrode current collector 4 or the negative electrode current collector 5, respectively, using a binder, and in the case of a bipolar battery, includes a bipolar electrode having a negative electrode layer configured by applying a negative electrode active material, etc. using binder to one side of the current collector and a negative electrode layer configured by applying a negative electrode active material, etc. using binder to the opposite side.

<Frame Member>

Next, the frame member 3 will be described More specifically based on FIGS. 2 and 3.

As shown in FIG. 2, the frame member 3 fixes the periphery of the separator 8 and seals the negative electrode composition layer 6 and the negative electrode composition layer 7 thereon. In the following description, the side of the frame member 3 on which the electrode composition 2 surrounded by the frame member 3 is disposed is referred to as the inside of the frame member 3. The outer circumference of the frame member 3 opposite the inner side is referred to as the outer side of the frame member 3.

FIG. 3 is a plan view of the frame member 3 viewed from the thickness direction.

As shown in FIG. 3, the frame member 3, which forms the outline of the battery cell 1, is formed in a shape of rectangular frame (picture frame) viewed from the thickness direction.

The frame member 3 is formed of, for example, an aramid resin. The molding processing temperature of the frame member 3 is, for example, 120° C. to 200° C. When this temperature range is exceeded, thermal decomposition occurs.

The frame member 3 has a fragile portion 9 formed in a part of the frame member 3. In this embodiment, for example, the fragile portion 9 is formed on a part of the long side of the frame member 3. The fragile portion 9 is more fragile than the other portions of the frame member 3 except where the fragile portion 9 is formed. The fragile portion 9 has an outer recess 10a formed on the outside of one side of the frame member 3 and an inner recess 10b formed on the inner side thereof. These recesses 10a and 10b form a thinned portion 11 that is thinner than other parts of the frame member 3. The thinned portion 11 serves as the fragile portion 9.

The outer recess 10a and the inner recess 10b are formed in a kind of an arc shape in terms of the thickness direction. However, the shape of each recess 10a, 10b is not particularly limited. It is sufficient if each recess 10a, 10b forms a thinned fragile portion 9. For example, the shape of each recess 10a, 10b may be triangular in the direction of thickness. The thinned fragile portions 9 are easier to melt than the other portions of the frame member 3. Specifically, the melting point of the fragile portion 9 is about 75° C. to 90° C.

<Effect of the Fragile Part in the Frame Member>

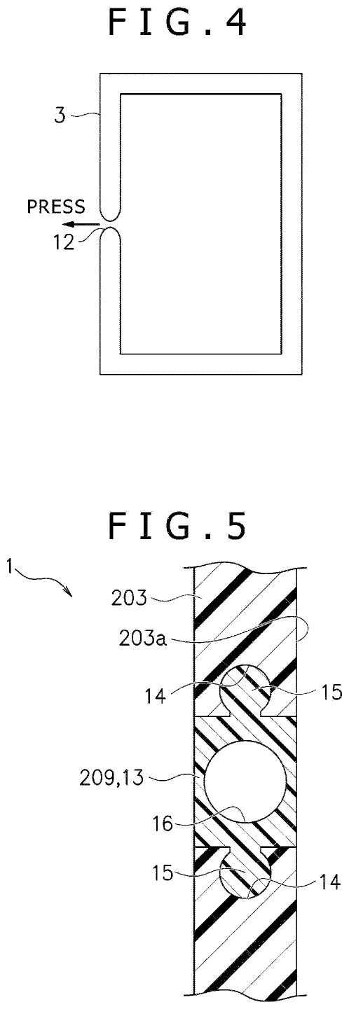

Next, the effect of the fragile portion 9 is explained based on FIG. 4.

By the way, when the battery cell 1 is discharged or overcharged at a high current, for example, gas may be generated in the electrode composition 2 and the pressure inside the frame member 3 may increase. In this case, the battery cell 1 expands because the temperature thereof also increases. For example, the battery cell 1 begins to expand at around 160° C.

FIG. 4 is an explanatory view of the effect of the frame member 3.

Here, the fragile portion 9 is formed in the frame member 3. Therefore, as shown in FIG. 4, when the temperature of the battery cell 1 begins to rise abnormally, the fragile portion 9 melts and an opening 12 is formed. The inside and outside of the frame member 3 are communicated through this opening 12. Since the melting point of the fragile portion 9 is, for example, about 75° C. to 90° C., The inside and outside of the frame member 3 are communicated before the battery cell 1 begins to expand or the pressure inside the frame member 3 rises. Therefore, the pressure inside the frame member 3 is released through the fragile portion 9 (the opening 12) where the inside and outside are communicated. Specifically, the fragile portion 9 serves as a pressure releasing portion that communicates the inside and outside of the frame member 3 when the pressure inside the frame member 3 increases beyond a certain level.

Thus, the battery cell 1 described above has the frame member 3 in which the fragile portion 9 is formed. This prevents the pressure inside the frame member 3 from increasing, thereby reliably preventing damage to the battery cell 1.

The fragile portion 9 is a thinned portion 11 of the frame member 3 formed by an outer recess 10a and an inner recess 10b. Forming the thinned portion 11 in this manner enables the fragile portion 9 to be easily provided.

In the first embodiment described above, the outer recess 10a and the inner recess 10b are formed in the frame member 3, and this thinned portion 11 is used as the fragile portion 9. However, the configuration is not limited to this, but it is sufficient if a thinned portion is formed in a part of the frame member 3 that is thinner than other parts. For example, a thinned portion that is thinner in the direction of thickness compared to other portions may be formed in a part of the frame member 3, and this thinned portion may serve as the fragile portion 9.

In the first embodiment described above, the separator 8 and each electrode collector 4, 5 may be made of aramid resin. Even if the frame member 3 is made of the same material as the separator 8 and each electrode collector 4, 5, the melting point of the fragile part 9 is lower than that of the separator 8 and the electrode collectors 4, 5. Therefore, the same effect as in the first embodiment described above is achieved.

Instead of aramid resins, polyvinylidene fluoride (PVdF), polytetrafluoroethylene, polyethylene, polypropylene, polyamide, polyimide, polyamideimide, polyvinyl alcohol, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyethersulfone, polyhexafluoropropylene, styrene-butadiene rubber, carboxymethylcellulose, etc., can also be used. One of these materials may be used alone or two or more may be used in combination.

### Second Embodiment

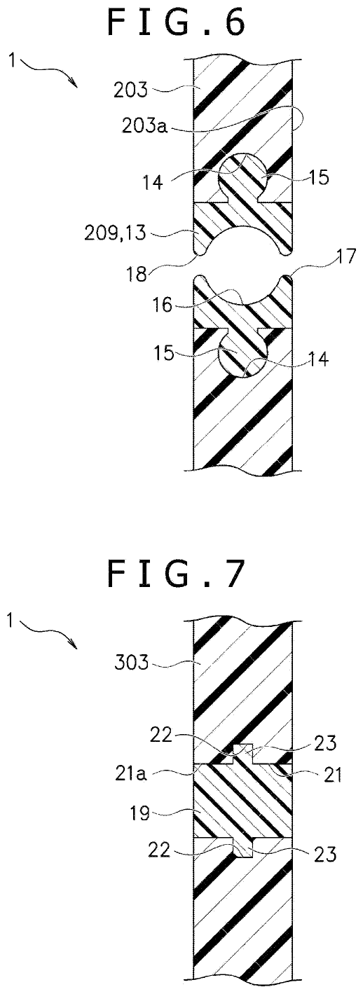

Next, the second embodiment of the present invention will be described based on FIGS. 5 and 6, with FIG. 2 as a support. Like numerals refer to like elements as in the first embodiment, and the explanation will be omitted.

In the second embodiment, the battery cell 1 has the same basic configuration as that in the first embodiment described above (the same goes for the third embodiment below); that is, it is provided with an electrode composition 2, a frame member 203 disposed annularly so as to surround around the outer periphery of the electrode composition 2 except both surfaces in the thickness direction, a negative electrode current collector 4 and a negative electrode current collector 5 which close the openings 203a of the frame member 203 from both sides in the thickness direction.

<Frame Members>

FIG. 5 is an enlarged plan view of the main part of the frame member 203 viewed from the thickness direction.

Here, as shown in FIG. 5, the difference between the first embodiment and the second embodiment is that the configuration of the fragile portion 9 formed in the frame member 3 of the first embodiment is different from the configuration of a fragile portions 209 formed in the frame member 203 of the second embodiment.

Specifically, the fragile portion 209 of the second embodiment is a low melting point portion 13 in the frame member 203 that has a lower melting point than that of the other area of the frame member 203. The low melting point portion 13 is formed, for example, of a material having a melting point of about 75° C. to 90° C. The low melting point portion 13 may be formed separately from the frame member 203 and then assembled to the frame member 203. The frame member 203 and the low melting point portion 13 may also be integrally molded. When the frame member 203 and the low melting point portion 13 are integrally molded, various injection molding methods such as two-color molding, sandwich molding, and ultra-high-speed injection molding can be employed.

A recess 14 is formed in the frame member 203 corresponding to the low melting point portion 13. The low-melting point portion 13 has a projection 15 that is fitted into the recess 14. The recess 14 and the projection 15 are composed of a dovetail recess and a dovetail projection fitted together, for example. This securely prevents the low melting point portion 13 (fragile portion 209) from falling out of the frame member 203. In addition, the dovetail recess is fitted with the dovetail projection, for example, so that, when the frame member 203 and the low melting point portion 13 are integrally molded, the anchor effect is achieved to securely prevent the low melting point portion 13 (fragile portion 209) from falling out of the frame member 203.

The low melting point portion 13 has an opening 16 that penetrates in the thickness direction through most of the central portion in terms of the thickness direction. Forming the opening 16 makes the thicknesses of the outer wall and the inner wall of the low melting point portion 13 thinner.

<Effect of the Fragile Part in the Frame Member>

Next, the effect of the fragile section 209 will be explained based on FIG. 6.

FIG. 6 is an explanatory view of the effect of the frame member 203.

Here, the low melting point portion 13 (the fragile portion 9) is provided in the frame member 3. Therefore, as shown in FIG. 6, when the temperature of the battery cell 1 begins to rise abnormally, the low melting point portion 13 melts. An opening 12 is formed in the low melting point portion 13, and thus an outer opening 17 and an inner opening 18 are formed due to melting of the low melting point portion 13. The inside and outside of the frame member 203 are communicated through these openings 16, 17, and 18. Since the melting point of the fragile portion 9 is, for example, about 75° C. to 90° C., the inside and outside of the frame member 3 are communicated before the battery cell 1 begins to expand or the pressure inside the frame member 3 rises. Therefore, the pressure inside the frame member 3 is released through the fragile portion 209 (the openings 16, 17, and 18) where the inside and outside are communicated. Specifically, the fragile portion 209 serves as a pressure releasing portion that communicates the inside and outside of the frame member 203 when the pressure inside the frame member 203 increases beyond a certain level.

Therefore, the second embodiment described above has the same effect as the first embodiment described above. In addition, by forming the opening 16 in the low melting point portion 13, the wall thickness of the low-melting portion 13 in the inner and outer directions can be made thinner. As a result, when the temperature of the battery cell 1 rises abnormally, the openings (the outer opening 17 and the inner opening 18) can be easily formed. Thus, the inner pressure of the frame member 3 can be more reliably released.

In the second embodiment described above, the case where the opening 16 is formed in the low melting point portion 13 has been described. However, the configuration is not limited to this, but the opening 16 may not be formed as long as the inside and outside of the frame member 203 can be communicated through the low melting point portion 13 when the temperature of the battery cell 1 rises abnormally.

### Third Embodiment

<Frame Member>

FIG. 7 is an enlarged plan view of a main part of a frame member 303 viewed from the thickness direction.

As shown in FIG. 7, in the third embodiment, the frame member 303 is provided with a plug 19 instead of the fragile portions 9, 209. This point differs from the first and second embodiments described above.

Specifically, an opening 21 is formed on a part of the long side of the frame member 303. An engagement recess 22 is formed in an inner peripheral surface 21a of the opening 21. The plug 19 is fitted to close the opening 21. The plug 19 is formed of the same material as, for example, the frame member 303. The plug 19 has an integrally molded engagement projection 23 that is engaged with the engagement recess 22. The strength of the engagement projection 23 is such that it is deformed or cracked when a certain external force is applied to the plug 19.

<Effect of the Plug in the Frame Member>

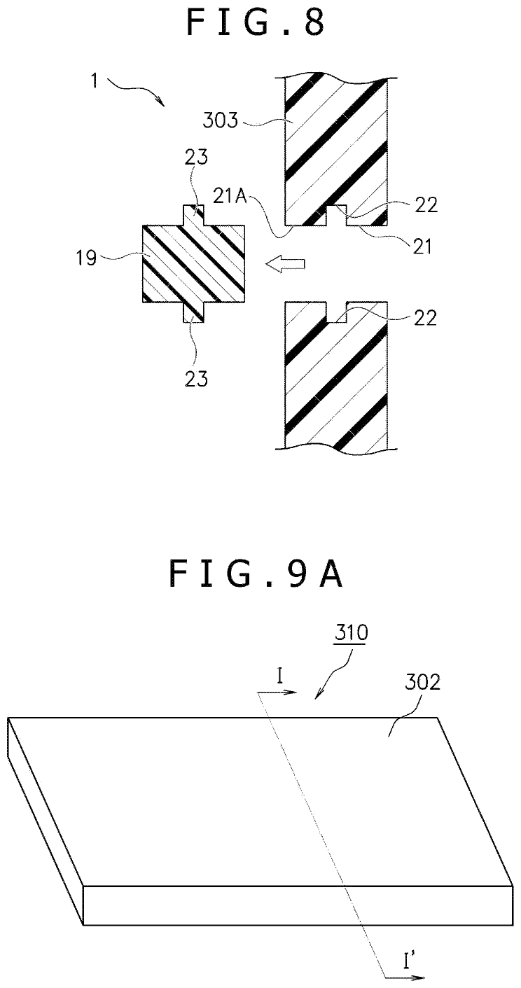

Next, the effect of the plug 19 will be explained based on FIG. 8.

As shown in FIG. 8, when the pressure inside the frame member 303 rises above a certain level, the inner surface of the frame member 303 and the inner end surface of the plug 19 is pressed outward. Then, the engagement projection 23 of the plug 19 is deformed or cracked, and the plug 19 is removed from the opening 21 of the frame member 303. This allows the inside and outside of the frame member 303 to be communicated through the opening 21 of the frame member 303, and the pressure inside of the frame member 303 is released. Specifically, the plug 19 serves as a pressure-relieving portion that communicates the inside and outside of the frame member 303 when the pressure inside the frame member 303 increases beyond a certain level.

Therefore, according to the third embodiment described above, the same effects as the first and second embodiments described above are achieved.

In the third embodiment described above, the case has been described in which a plug 19 is provided in the frame member 303, and the plug 19 is removed when the pressure inside the frame member 303 increases beyond a certain level. However, the configuration is not limited to this, but it is sufficient that the inside and outside of the frame member 303 can be communicated when the pressure inside the frame member 303 increases beyond a certain level. For example, a membrane body that breaks when the pressure inside the frame member 303 increases above a certain level may be provided instead of the plug 19. By breaking the membrane body, the inside and outside of the frame member 303 are communicated.

The present invention is not limited to the embodiments described above, but includes various modifications to the above embodiments to the extent that they do not depart from the gist of the present invention.

For example, in the first and second embodiments described above, the cases have been described in which the fragile portions 9, 209 are formed on a part of the long side of the frame members 3, 203. In the third embodiment described above, the case where the plug 19 is provided on a part of a long side of the frame member 303 has been described. However, the configuration is not limited to this, but it is sufficient that the fragile portions 9, 209 or the plug 19 are formed on a part of the frame members 3, 203, 303. For example, the fragile portions 9, 209 or the plug 19 may be formed or provided on a part of a short side of the frame members 3, 203, 303. 209 or plug 19 can be formed or provided on some of the short sides of the frame members 3, 203, 303. Further, the fragile portions 9, 209 may be formed or the plug 19 may be provided in only one of the frame members 3, 203, 303 disposed around the negative electrode composition layer 6 or the frame members 3, 203, 303 disposed around the negative electrode composition layer 7.

In the above embodiment, the case has been described where the electrode composition 2 is composed of the negative electrode composition layer 6 containing the negative electrode active material particles and the negative electrode composition layer 7 containing the negative electrode active material particles that are laminated via a separator 8. However, the configuration is not limited to this, but the electrode composition 2 may be composed of a single kind of electrode composition layer.

In the embodiment described above, the case is also described in which the openings 3a, 203a are closed from both sides in the thickness direction by each electrode collector 4, 5. However, the configuration is not limited to this, but, instead of each pole collector 4, 5, a base material may be provided that simply closes the openings 3a, 203a of the frame members 3, 203, 303.

As described above, a battery cell according to one embodiment of the present invention is provided with an electrode composition containing electrode active material particles a frame member placed annularly so as to surround the electrode composition; and a base material for closing openings of the frame member from both sides in the thickness direction, wherein the frame member has a pressure releasing portion for communicating inside and outside of the frame member when the pressure inside the frame member increases above a certain level.

In an embodiment described above, the pressure releasing portion may be provided in a certain area of the frame member, and is a fragile portion that is more fragile than areas of the frame member except the certain area.

In an embodiment described above, the fragile portion may be a thinned portion that is formed thinner than the other area of the frame member.

In an embodiment described above, the fragile portion may be a low melting point portion that has a lower melting point than that of the other area of the frame member.

In one embodiment described above, the electrode composition consists of a negative electrode composition layer and a negative electrode composition layer that are laminated via a separator; and the base material is an electrode current collector.

### Second Embodiment

Subsequently, a lithium-ion battery according to the second embodiment will be described.

Lithium-ion batteries have been attracting attention as high-capacity, compact, and lightweight rechargeable batteries. A typical lithium-ion battery consists of a negative electrode active material layer containing negative active material, binder resin, and electrolyte, and a negative electrode active material layer also containing negative active material, binder resin, and electrolyte, that are laminated with a separator therebetween and stored in a container.

In recent years, recycling of battery materials has been widely considered from the viewpoint of resource recycling. However, in the above-mentioned typical lithium-ion batteries, it has been difficult to recycle because the active materials or the active material and the electrode (or the current collector) are bound to each other by a binder. For the purpose of solving such a problem, a technology to recycle the active material layer has been proposed, as in, for example, Patent Literature 2.

However, although it is possible to reuse the active material layer as described in Patent Literature 2, it is difficult to disassemble each element that constitutes a single battery in the process of recycling battery materials, and improvement has been needed regarding the easy recovery of the active material layer.

The purpose of the second aspect is to provide a lithium-ion battery and a method for producing regenerated electrode active material, in which the active material layer can be easily recovered.

As a result of earnest examination based on the above findings, the inventors have conceived of a series of diligent examinations and have arrived at the various aspects of the present invention shown below.

A lithium-ion battery having an electrode composition, a current collector, and a separator, the electrode composition layer containing coated active material in which at least a part of the surface of an electrode active material is coated with a coating material containing polymer compound, the lithium-ion battery comprising:
a frame member for fixing a peripheral portion of the separator that is placed between a pair of current collectors,
wherein the frame member has a protruding portion that protrudes outward in a plane direction from an edge of the current collector when viewing the single battery from the laminating direction,
the frame member or the protruding portion has a pressure releasing portion that communicates inside and outside of the frame member when the pressure inside the frame member increases above a certain level.

According to the second aspect, it is possible to provide a lithium-ion battery and a method for producing regenerated electrode active material in which the active material layer can be easily recovered.

### First Embodiment

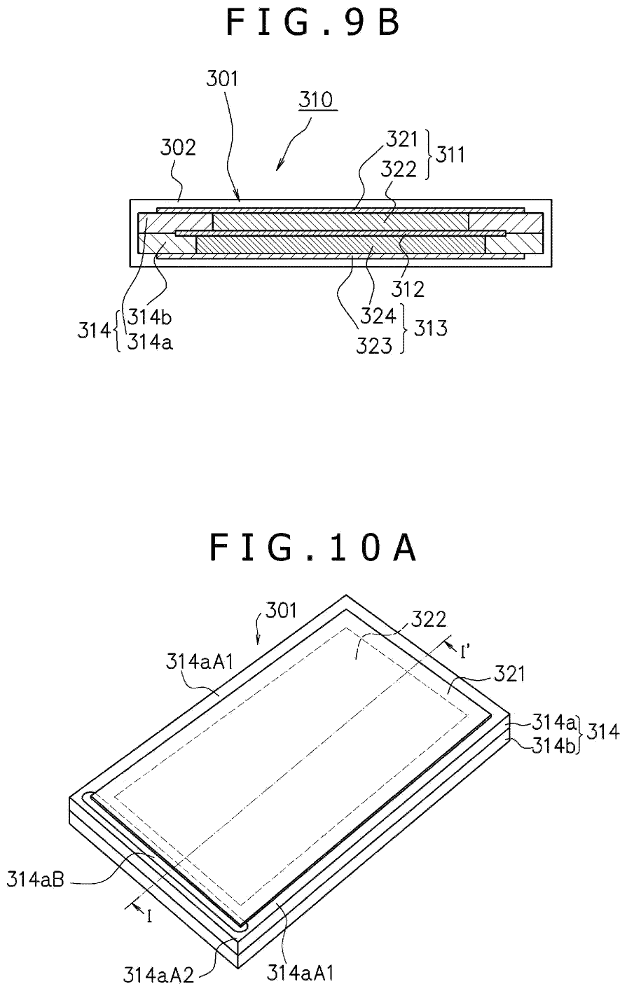

First, the lithium-ion secondary battery according to the first embodiment will be described. FIGS. 9A and 9B are schematic diagrams showing a lithium-ion secondary battery according to this embodiment. FIG. 9A is a schematic perspective view and FIG. 9B is a schematic cross sectional view along I-I′ of FIG. 9A.

As shown in FIGS. 9A and 9B, the lithium-ion rechargeable battery 310 consists of a flat plate type single battery structure 301, and an exterior film 302 covering the single battery structure 301.

The single battery structure 301 consists of a positive electrode 311 and a negative electrode 313 that are laminated via a separator 312. The positive electrode 311 consists of a positive electrode current collector 321 and a positive electrode active material layer 322 that are laminated. The negative electrode 313 consists of a negative electrode current collector 323 and a negative electrode active material layer 324 are laminated. The frame member 314 is placed between the positive electrode current collector 321 and the negative electrode current collector 323 to fix the periphery of the separator 312 so as to seal the positive electrode active material layer 322, the separator 312 and the negative electrode active material layer 324. The sealed interior is filled with electrolyte to form the single battery structure 301. Since the positive electrode current collector 321 and the negative electrode current collector 323 are flexible, the lithium-ion secondary battery 310 is flexible.

<Negative Electrode Current Collector>

The current collector is preferably a resin current collector made of conductive polymer material. For example, conductive polymers or resins with conductive agents added as necessary can be used as conductive polymer materials constituting the resin current collector.

The positive electrode current collector 321 preferably includes a conductive filler and matrix resin. The conductive filler is selected from conductive materials such as metal and carbon.

<Negative Electrode Active Material Layer>

The positive electrode active material layer 322 is preferably a non-bound body of a mixture containing negative electrode active materials. Here, the non-bound body means that the position of the negative electrode active material is not fixed in the negative electrode active material layer and that the negative electrode active materials are not irreversibly fixed to each other and to the negative electrode active material and current collector.

When the positive electrode active material layer 322 is non-bound body, the negative electrode active materials are not irreversibly fixed to each other, and thus can be separated without mechanically destroying the interface between the negative electrode active materials. This is preferable because it is possible to prevent the destruction of the positive electrode active material layer 322 by the movement of the negative electrode active material even when stress is applied to the positive electrode active material layer 322. The positive electrode active material layer 322, which is a non-bound body, can be obtained by such methods as turning the negative electrode active material layer 313 into a positive electrode active material layer 322 that contains the negative electrode active material and the electrolyte and does not contain a binding agent 322.

<Negative Electrode Current Collector

The negative electrode current collector 323, for which the same method to obtain the negative electrode current collector 323 can be suitably selected used, can be obtained by the similar method.

<Negative Electrode Active Material Layer>

The negative electrode active material layer 324 is preferably a non-bound body of a mixture containing negative electrode active material. The reasons why it is preferable for the positive electrode active material layer 322 to be a non-bound body and the method for obtaining the positive electrode active material layer 322 as a non-bound body are the same as those for obtaining the negative electrode active material layer 323 as a non-bound body.

<Frame Member>

The material as the frame member 314 is not particularly limited as long as that is durable against electrolyte, but polymeric materials are preferred, and thermosetting polymeric materials are more preferred. Specifically, examples thereof include epoxy resins, polyolefin resins, polyurethane resins, and polyvinylidene fluoride resins, and epoxy resins are preferred because of their high durability and easy handling.

The lithium-ion battery 301 has the configuration in which the electrolyte is sealed by sealing the outer circumference of the positive electrode active material layer 322 and the negative electrode active material layer 323. The method of sealing the outer circumference of the positive electrode active material layer 322 and the negative electrode active material layer 323 is, for example, a method of using a frame member 314 to seal the outer circumference of the positive electrode active material layer 322 and the negative electrode active material layer 323. The frame member 314 is disposed between the positive electrode current collector 321 and the negative electrode current collector 323, and serves to seal the outer circumference of the separator 312.

<Specific Configuration of a Single Battery Structure>

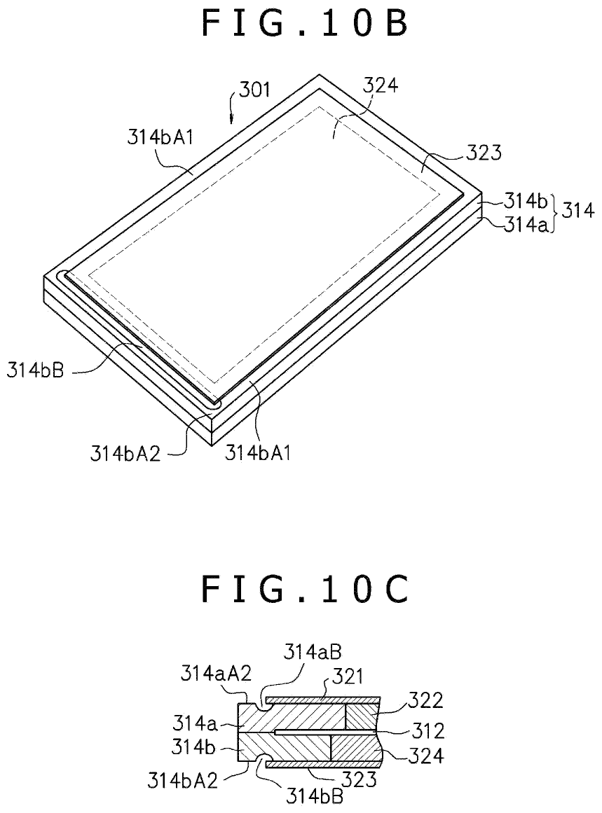

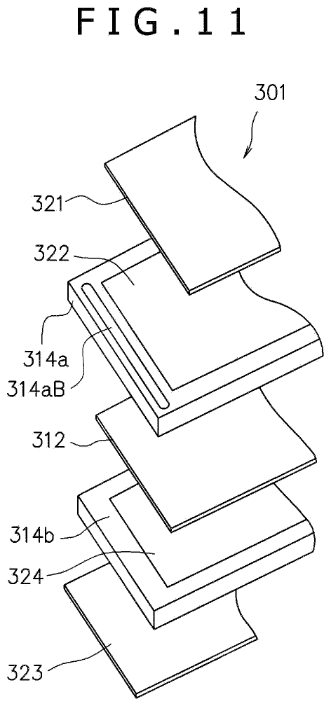

FIGS. 10A to 10C are schematic diagrams showing the appearance of the single battery structure of a lithium-ion secondary battery, with FIG. 10A is a schematic perspective view showing one main surface, FIG. 10B is a schematic perspective view showing the other main surface, and FIG. 10C is a schematic cross sectional view along I-I′ of FIG. 10A. FIG. 11 is a schematic diagram showing the single battery structure of the lithium-ion secondary battery according to this embodiment that is disassembled by component.

In the single battery structure 301 of the lithium-ion secondary battery 310, the frame members 314 has a positive electrode side frame member 314a disposed on the side of the positive electrode 311 and a negative electrode side frame member 314b disposed on the side of the negative electrode 313.

As shown in FIG. 10A, the positive electrode side frame member 314a has, when viewing the single battery structure 301 from the lamination direction, a protruding portion 314aA1 that protrudes from the two long sides out of the peripheral edges of the positive electrode current collector 321 in the direction outward in the plane direction and substantially perpendicular to the direction of extension of the long side, and a protruding portion 314aA1 that protrudes from the short side out of the peripheral edges of the positive electrode current collector 321 in the direction outward in the plane direction and substantially perpendicular to the direction of extension of the short side. The protruding portions 314aA1 and 314aA2 are not covered by the positive electrode current collector 321, i.e., exposed portions of the positive electrode side frame member 314a on the back surface of the single battery structure 301.

As shown in FIG. 10B, the negative electrode side frame member 314b has, when viewing the single battery structure 301 from the lamination direction, a protruding portion 314bA1 that protrudes from the two long sides out of the peripheral edges of the negative electrode current collector 323 in the direction outward in the plane direction and substantially perpendicular to the direction of extension of the long side, and a protruding portion 314bA1 that protrudes from the short side out of the peripheral edges of the negative electrode current collector 323 in the direction outward in the plane direction and substantially perpendicular to the direction of extension of the short side. The protruding portions 314bA1 and 314bA2 are not covered by the negative electrode current collector 323, i.e., exposed portions of the negative electrode side frame member 314b on the back surface of the single battery structure 301.

The protruding portion 314aA of the positive electrode side frame member 314a has a groove-shaped negative electrode side recess 314 AB formed by cutting in a groove shape along one short side. The positive electrode current collector 321 covers the surface of the positive electrode active material layer 322, and is joined to the negative electrode side frame member 314a. Here, as shown in FIG. 10C, the edge of the positive electrode current collector 321 located on the positive electrode side recess 314aB along the positive electrode side recess 314aB forms a gap with respect to the positive electrode side recess 314aB due to the existence of the positive electrode side recess 314aB formed on the positive electrode side frame member 314a, and thus the back surface of the resin near the edge is exposed inside the positive electrode side recess 314aB.

The protruding portion 314bA of the negative electrode side frame member 314b has a groove-shaped negative electrode side recess 314 AB formed by cutting in a groove shape along one short side. The negative electrode current collector 323 covers the surface of the negative electrode active material layer 324, and is joined to the positive electrode side frame member 314b. Here, as shown in FIG. 10C, the edge of the negative electrode current collector 323 located on the negative electrode side recess 314bB along the negative electrode side recess 314bB forms a gap with respect to the negative electrode side recess 314bB due to the existence of the negative electrode side recess 314bB formed on the negative electrode side frame member 314b, and thus the back surface of the resin near the edge is exposed inside the negative electrode side recess 314bB.

As shown in FIGS. 9A, 9B and 10C, the positive electrode active material layer 322 is held by the positive electrode side frame member 314a, and is sealed by being covered its front surface by the positive electrode current collector 321 and its back surface by the separator 312. The positive electrode active material layer 322 is held by the positive electrode side frame member 314a, and is sealed by being covered its front surface by the positive electrode current collector 321 and its back surface by the separator 312.

In the frame member 314 or the protruding portion, a pressure releasing portion (not shown) is formed to communicate the inside and outside of the frame member 314 when the pressure inside the frame member 314 increases beyond a certain level, as in the first case described above.

Specifically, as the pressure releasing portion, a structure similar to the fragile portion 9 in FIG. 3 in the first manner, the fragile portion 209 in FIG. 5, the fragile portion 209 in FIG. 6 and the plug 19 in FIG. 7 is formed.

<Method of Manufacturing Single Battery Structure>

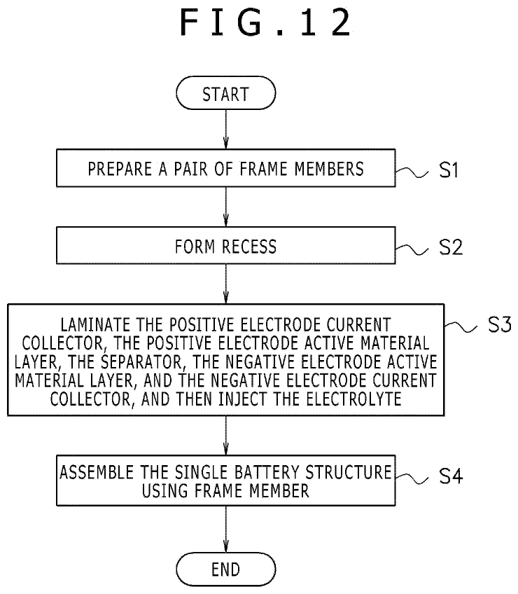

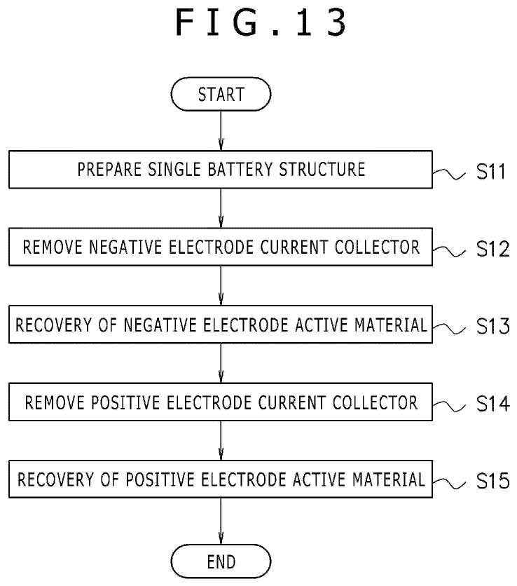

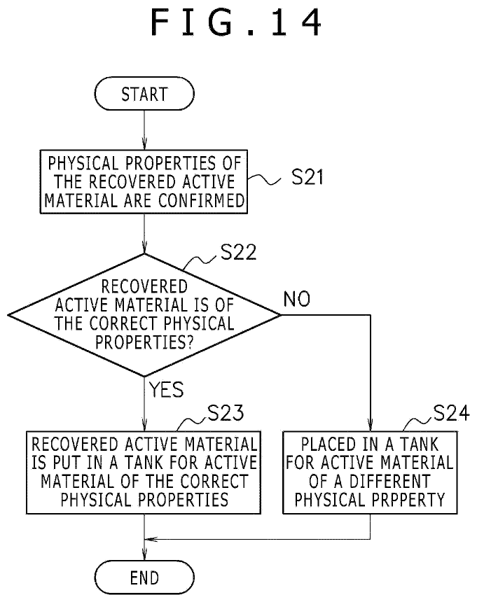

In this embodiment, the single battery structure 301 is fabricated by the fabrication process, and is made available to reuse by the recycling process and the confirmation process. FIG. 12 is a flow diagram showing the manufacturing process, FIG. 13 is a flow diagram showing the recycling process, and FIG. 14 is a flow diagram showing the segregation process.

(Fabrication Process)

First, a set of frame members is prepared (step S1). Each frame member is to be the positive electrode side frame member 314a and the negative electrode side frame member 314b.

Then, the positive electrode side recess 314aB and the negative electrode side recess 314bB are formed in the protruding portion 314aA2 of the positive electrode side frame member 314a and the protruding portion 314bA2 of the negative electrode side frame member 314b, respectively (step S2).

Then, the positive electrode current collector 321, the positive electrode active material layer 322, the separator 312, the negative electrode active material layer 324, and the negative electrode current collector 323 are laminated in this order, and then the electrolyte is injected (step S3).

Subsequently, the single battery structure 301 is assembled using frame member 314 (step S4).

More specifically, as shown in FIG. 11, the front surface of the positive electrode side frame member 314a (the surface on which the positive electrode side recess 314aB is formed) is disposed to face the positive electrode current collector 321, and the front surface of the negative electrode side frame member 314b (the surface on which the negative electrode side recess 314bB is formed) is disposed to face the negative electrode current collector 323. The outer circumference of the positive electrode active material layer 322 is sealed with the positive electrode side frame member 314a, and the outer circumference of the negative electrode active material layer 324 is sealed with the negative electrode side frame member 314b. The positive electrode side frame member 314a is joined to the positive electrode current collector 321, and the front surface of the negative electrode side frame member 314b is joined to the front surface of the negative electrode side frame member 314b. The positive electrode side frame member 314a and the negative electrode side frame member 314b are joined together with the separator 312 sandwiched therebetween.

At this time, as shown in FIG. 10A, on the surface of the positive electrode side frame member 314a, the protruding portion 314aA1 is exposed which protrudes from the two peripheral edges of the positive electrode current collector 321 in the direction outward from the face direction and substantially perpendicular to the direction of extension of the long side when viewing the single battery structure 301 from the lamination direction.

As shown in FIG. 10B, on the surface of the negative electrode side frame member 314b, the protruding portion 314bA1 is exposed which protrudes from the two peripheral edges of the negative electrode current collector 323 in the direction outward from the face direction and substantially perpendicular to the direction of extension of the long side when viewing the single battery structure 301 from the lamination direction.

Furthermore, as in FIGS. 10A and 10C, the edge of the positive electrode current collector 321 located on the positive electrode side recess 314aB along the positive electrode side recess 314aB forms a gap with respect to the positive electrode side recess 314aB due to the existence of the positive electrode side recess 314aB formed on the positive electrode side frame member 314a, and thus the back surface of the resin near the edge is exposed inside the positive electrode side recess 314aB.

As in FIGS. 10B and 10C, the edge of the negative electrode current collector 323 located on the negative electrode side recess 314bB along the negative electrode side recess 314bB forms a gap with respect to the negative electrode side recess 314bB due to the existence of the negative electrode side recess 314bB formed on the negative electrode side frame member 314b, and thus the back surface of the resin near the edge is exposed inside the negative electrode side recess 314bB.

(Recycling Process)

In the recovered lithium-ion rechargeable battery 310 that has been used, the single battery structure 1 is recycled and processed as follows.

First, the exterior film 2 is removed from the lithium-ion secondary battery 310 to be recycled to take out the single battery structure 301 (step S11).

Subsequently, the negative electrode current collector 23 is peeled off and removed from the single battery structure 1 (step S12).

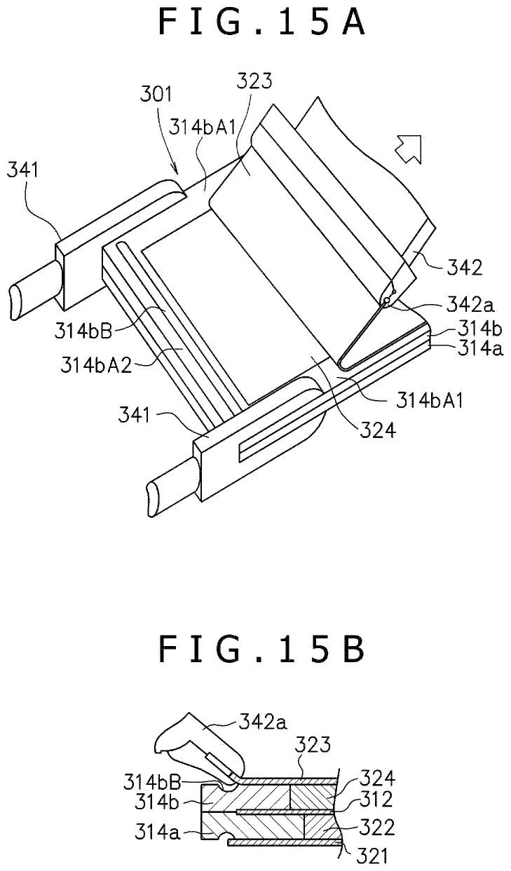

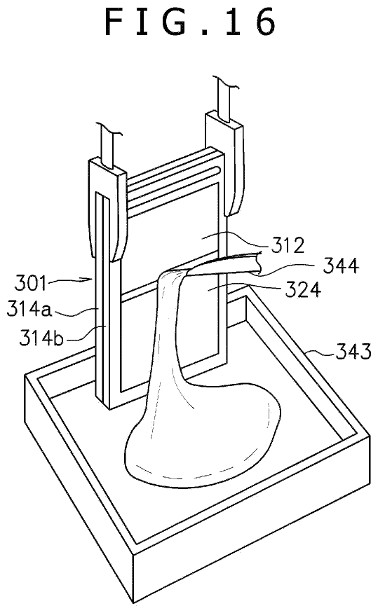

More specifically, as shown in FIG. 15A, the single battery structure 301 is fixed by grasping the protruding portions 314bA1, 314aA1 of the single battery structure 301 using the grasping fixture 341. The protruding portions 314bA1, 314aA1 are provided so that the grasping fixture 341 can grasp the protruding portions 314bA, 314aA1 more stably and securely.

In this state, as shown in FIG. 15B, a peeling tool 342 having a claw 342a that has the width substantially equal to the width of the short side of the negative electrode current collector 323 is used to insert the tip of the claw 324a of the peeling tool 342 into the negative electrode side recess 314bB of the negative electrode side frame member 314b, and the region near the edge of the negative electrode current collector 323 exposed in the negative electrode side recess 314bB is grasped by the claw 342a. The presence of negative electrode side recess 314bB allows the claw 342a to be easily inserted into the negative electrode side recess 314bB, thereby easily and surely grasping the region near the edge of the exposed negative electrode current collector 323 by the claw 342a. Then, as shown in FIG. 15A, the negative electrode current collector 323 is peeled off from the negative electrode side frame member 314b. The claw 342a, that has a width substantially equal to the width of the short side of the negative electrode current collector 323, holds the region near the edge of the negative electrode current collector 323 over the entire width of the short edge, so that a uniform force is applied to the negative electrode current collector 323 over the entire width of the short edge. The negative electrode current collector 323 is thus peeled off without leaving any residue.

When peeling off the negative electrode current collector 323, the negative electrode side frame member 314 b may be heated using a heater or the like to make peeling easier. The heating temperature is set to about 200° C., for example.

Subsequently, the negative electrode active material layer 324 exposed from the negative electrode side frame member 314b is recovered (step S13).

More specifically, as shown in FIG. 16, the single battery structure 301, which is fixed by the grasping fixture 341, is vertically provided in a box-shaped recovery section 343, a nozzle 344 is used to spray dissolving solution onto the negative electrode active material layer 324 so as to dissolve the negative electrode active material layer 324, and the negative electrode active material is flushed into the recovery section 343 and removed. The negative electrode active material in a liquid form that is contained in the recovery section 343 is recovered.

Subsequently, the positive electrode current collector 321 is peeled off and removed from the single battery structure 301 (step S14).

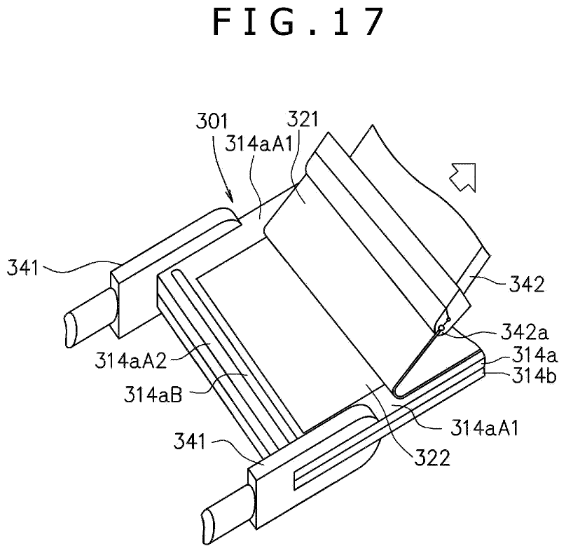

More specifically, as shown in FIG. 17, the single battery structure 301 is fixed by grasping the protruding portions 314aA1, 314bA1 of the single battery structure 301 using the grasping fixture 341. The protruding portions 314aA1, 314bA1 are provided so that the grasping fixture 341 can grasp the protruding portions 314aA, 314bA1 more stably and securely.

In this state, a peeling tool 342 having a claw 342a that has the width substantially equal to the width of the short side of the positive electrode current collector 321 is used to insert the tip of the claw 324a of the peeling tool 342 into the positive electrode side recess 314bB of the positive electrode side frame member 314a, and the region near the edge of the positive electrode current collector 323 exposed in the positive electrode side recess 314aB is grasped by the claw 342a. The presence of positive electrode side recess 314aB allows the claw 342a to be easily inserted into the positive electrode side recess 314aB, thereby easily and surely grasping the region near the edge of the exposed positive electrode current collector 321 by the claw 342a. Then, as shown in FIG. 17, the positive electrode current collector 321 is peeled off from the positive electrode side frame member 314a. The claw 342a, that has a width substantially equal to the width of the short side of the positive electrode current collector 321, holds the region near the edge of the positive electrode current collector 321 over the entire width of the short edge, so that a uniform force is applied to the positive electrode current collector 321 over the entire width of the short edge. The positive electrode current collector 321 is thus peeled off without leaving any residue.

When peeling off the positive electrode current collector 321, the positive electrode side frame member 314a may be heated using a heater or the like to make peeling easier. The heating temperature is set to about 200° C., for example.

Subsequently, the negative electrode active material layer 324 exposed from the negative electrode side frame member 314a is recovered (step S15).

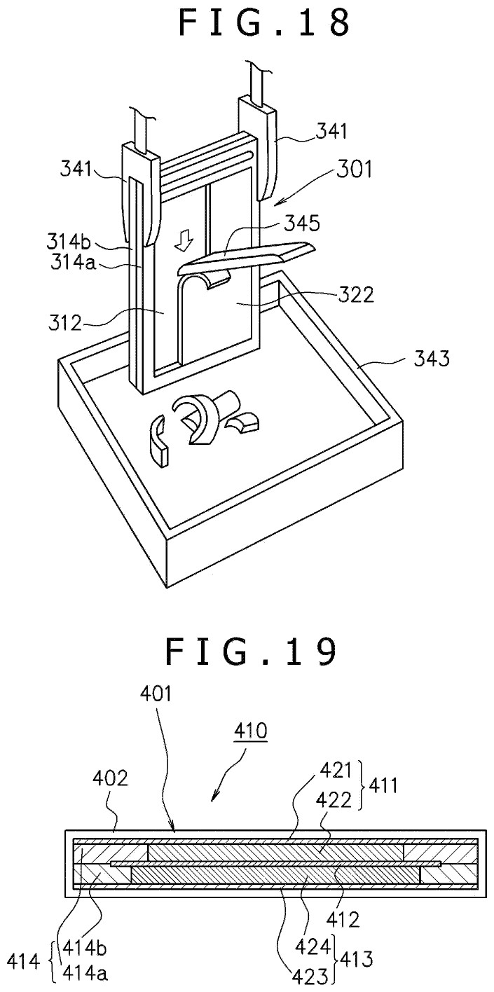

More specifically, as shown in FIG. 18, the single battery structure 301, which is fixed by the grasping fixture 341, is vertically provided in a box-shaped recovery section 342, a scraper 344 is used to scrape and remove the positive electrode active material layer 322. The negative electrode active material that is contained in the recovery section 343 is recovered. When manufacturing a single battery structure 301, a thin film for the backing may be formed between the positive electrode active material layer 322 and the separator 312 so that the positive electrode active material can be ensured.

(Segregation Process)

As shown in FIG. 14, the recovered active materials (the positive electrode active material in the positive electrode active material layer 322 and the negative electrode active material in the negative electrode active material layer 324) are segregated.

First, the physical properties of the recovered active material are confirmed (step S21).

Subsequently, it is checked whether the recovered active material is of the correct physical properties or not (step S22).

If the active material is determined to be of the correct physical properties in step S21, the recovered active material is put in a tank for active material of the correct physical properties (step S23). On the other hand, if it is determined in step S21 that the active material is not of the correct physical property, it is placed in a tank for active material of a different physical property (step S24).

This segregation process makes it possible to segregate the active materials to be recycled so that active materials with different physical properties are not mixed.

As explained above, according to this embodiment, the frame members 314 (the positive electrode side frame member 314a and the negative electrode side frame member 314b) have the recesses (the positive electrode side recess 314aB and the negative electrode side recess 314bB) that exposes the edges of the current collectors (the positive electrode current collector 321 and the negative electrode current collector 323). This makes it easy to grasp the edges of the current collector when peeling off the current collector and allows easy peeling. After the current collector is peeled off, the active material layers (the negative electrode active material layer 324 and the positive electrode active material layer 322) can be recovered reliably, so that the active material layers can be easily recovered in the recycling process.

[Second Aspect]

Next, the lithium-ion secondary battery according to the second embodiment will be described. FIG. 19 is a schematic cross sectional view showing a lithium-ion secondary battery according to this embodiment, corresponding to the schematic cross sectional view of FIG. 9B in the first embodiment.

As shown in FIG. 19, the lithium-ion rechargeable battery 410 consists of a flat plate type single battery structure 401, and an exterior film 402 covering the single battery structure 401.

The single battery structure 401 consists of a positive electrode 411 and a negative electrode 413 that are laminated via a separator 412. The positive electrode 411 consists of a positive electrode current collector 421 and a positive electrode active material layer 422 that are laminated. The negative electrode 413 consists of a negative electrode current collector 423 and a negative electrode active material layer 424 are laminated. The frame member 414 is placed between the positive electrode current collector 421 and the negative electrode current collector 424 to fix the periphery of the separator 412 so as to seal the positive electrode active material layer 422, the separator 412 and the negative electrode active material layer 424. The sealed interior is filled with electrolyte to form the single battery structure 401. Since the positive electrode current collector 421 and the negative electrode current collector 423 are flexible, the lithium-ion secondary battery 410 is flexible.

<Specific Configuration of a Single Battery Structure>

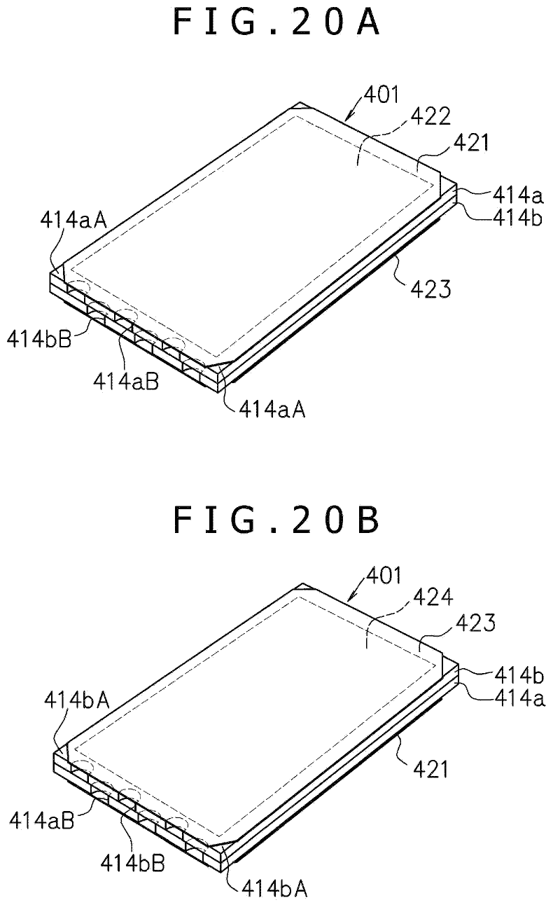

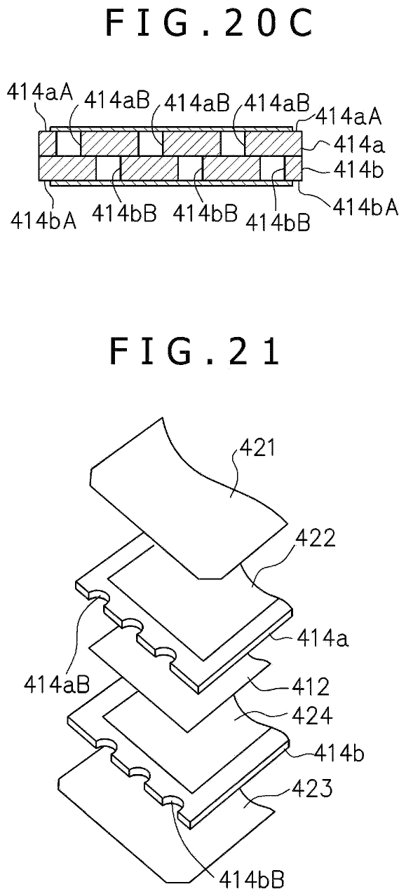

FIGS. 20A to 20C are schematic diagrams showing the appearance of the single battery structure of a lithium-ion secondary battery, with FIG. 20A is a schematic perspective view showing one main surface, FIG. 20B is a schematic perspective view showing the other main surface, and FIG. 20C is a schematic cross sectional view along I-I′ of FIG. 20A. FIG. 21 is a schematic diagram showing the single battery structure of the lithium-ion secondary battery according to this embodiment that is disassembled by component.

In the single battery structure 401 of the lithium-ion secondary battery 410, the frame members 414 has a positive electrode side frame member 414a disposed on the side of the positive electrode 411 and a negative electrode side frame member 414b disposed on the side of the negative electrode 313.

As shown in FIG. 20A, the positive electrode side frame member 414a has, when viewing the single battery structure 401 from the lamination direction, a protruding portion 414aA1 that protrudes at least at two corners on the short sides out of four corners of the positive electrode current collector 421 in the direction outward in the plane direction. The protruding portion 414aA is not covered by the positive electrode current collector 421, i.e., exposed portions of the positive electrode side frame member 414a on the back surface of the single battery structure 401.

As shown in FIG. 20B, the negative electrode side frame member 414b has, when viewing the single battery structure 401 from the lamination direction, a protruding portion 414bA1 that protrudes at least at two corners on the short sides out of four corners of the negative electrode current collector 423 in the direction outward in the plane direction. The protruding portion 414bA is not covered by the negative electrode current collector 423, i.e., exposed portions of the negative electrode side frame member 414b on the back surface of the single battery structure 401.

As shown in FIG. 20C, the positive electrode side frame member 414a has three positive electrode side recesses 414aB (three in the example shown in the figure) that are cut to penetrate in the thickness direction at the edge region of one short side.

As shown in FIG. 20C, the negative electrode side frame member 414bB has three positive electrode side recesses 414aB (three in the example shown in the figure), which are notched through in the thickness direction at the edge region of one short side. As shown in FIG. 20C, the negative electrode side frame member 414B has three negative electrode side recesses 414BB (three in the example shown in the figure) that are notched through in the thickness direction at the edge region of one short side. As shown in FIG. 20C, the negative electrode side frame member 414B has three recesses 414BB (three in the example shown in the figure), which are notched through in the thickness direction at the edge region of one short side.

The positive electrode side recess 414aB and the negative electrode side recess 414bB are formed at different positions in the lamination direction (mutually opposite positions in the illustrated example), as shown in FIG. 20C.

The positive electrode current collector 421 covers the surface of the positive electrode side frame member 414a up to the edge of the positive electrode side frame member 414a and is joined to the positive electrode side frame member 414a. Here, as shown in FIGS. 20A and 20B, the positive electrode current collector 421 covers the upper part of the positive electrode side recess 414aB and a gap is formed with respect to the positive electrode side recess 414aB, which is exposed from the edge of one short side of the positive electrode current collector 421.

The positive electrode current collector 421 covers the surface of the positive electrode side frame member 414a up to the edge of the positive electrode side frame member 414a and is joined to the positive electrode side frame member 414a. Here, as shown in FIGS. 20A and 20B, the positive electrode current collector 421 covers the upper part of the positive electrode side recess 414aB and a gap is formed with respect to the positive electrode side recess 414aB, which is exposed from the edge of one short side of the positive electrode current collector 421.

If the positive electrode side recess 414aB and the negative electrode side recess 414bB are provided in the same position (or partially overlap) in the lamination direction, the positive electrode current collector 421 and the negative electrode current collector 423 may come into contact and thus electrically conducted through the positive electrode side recess 414aB and the negative electrode side recess 414bB when the single battery structure 401 is assembled. In this embodiment, the positive electrode side recess 414aB and the negative electrode side recess 414bB are provided at different positions in the lamination direction, so that the positive electrode current collector 421 and the negative electrode current collector 423 can avoid the risk of coming into contact with each other and electrically conducted.

In this embodiment, the electronic components described below may be disposed in the positive electrode side frame member 414a or the negative electrode side frame member 414b, e.g., in a part of the protruding portion 414aA of the negative pole side frame member 414a, similar to the first embodiment.

<Method of Manufacturing Single Battery Structure>

In this embodiment, the single battery structure 401 is fabricated by the fabrication process, and is made available to reuse by the recycling process and the confirmation process, similar to the first embodiment.

(Fabrication Process)

Similar to FIG. 12, a set of frame members is prepared (step S1). Each frame member is to be the positive electrode side frame member 414a and the negative electrode side frame member 414b.

Then, the positive electrode side recess 414aB that penetrates in the thickness direction of the positive electrode side frame member 414a is formed in the edge region in one short side of the positive electrode side frame member 414a. The negative electrode side recess 414bB that penetrates in the thickness direction of the negative electrode side frame member 414b is formed in the edge region in one short side of the negative electrode side frame member 414b (step S2).

Then, the positive electrode current collector 421, the positive electrode active material layer 422, the separator 412, the negative electrode active material layer 424, and the negative electrode current collector 423 are laminated in this order, and then the electrolyte is injected (step S3).

Subsequently, the single battery structure 401 is assembled using frame member 314 (step S4).

More specifically, as shown in FIG. 21, the front surface of the positive electrode side frame member 414a is disposed to face the positive electrode current collector 421, and the front surface of the negative electrode side frame member 414b is disposed to face the negative electrode current collector 423. The outer circumference of the positive electrode active material layer 422 is sealed with the positive electrode side frame member 414a, and the outer circumference of the negative electrode active material layer 424 is sealed with the negative electrode side frame member 414b. The positive electrode side frame member 414a is joined to the positive electrode current collector 421, and the front surface of the negative electrode side frame member 414b is joined to the front surface of the negative electrode side frame member 414b. The positive electrode side frame member 414a and the negative electrode side frame member 314b are joined together with the separator 412 sandwiched therebetween.

In this case, as shown in FIG. 20A to FIG. 20C, the negative electrode side frame member 414a and the negative electrode side frame member 414b are joined so that positional deviation in the laminating direction occurs between the positive electrode side recesses 414aB and the negative pole side recesses 414bB. Then, at the edge of one short side of the single battery structure 401, the gap formed by the positive electrode side recess 414aB and the positive electrode current collector 421, and the gap formed by the negative electrode side recess 414bB and the negative electrode current collector 423 are exposed.

(Recycling Process)

As in the first embodiment, In the recovered lithium-ion rechargeable battery 410 that has been used, the single battery structure 1 is recycled and processed as follows.

As in FIG. 13, first, the exterior film 402 is removed from the lithium-ion secondary battery 410 to be recycled to take out the single battery structure 401 (step S11).

Subsequently, the negative electrode current collector 23 is peeled off and removed from the single battery structure 1 (step S12).

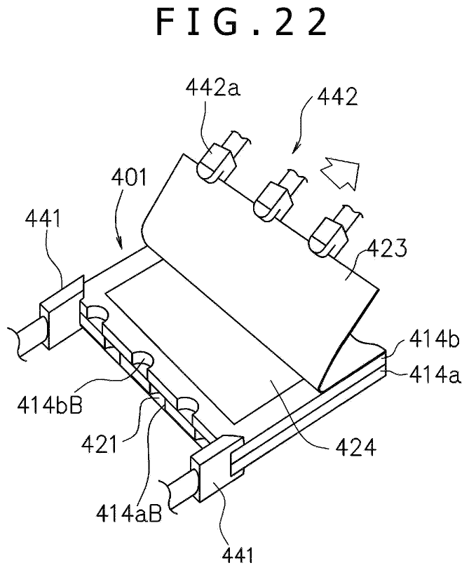

More specifically, as shown in FIG. 22A, the single battery structure 401 is fixed by grasping the protruding portions 414bA1, 414aA1 of the single battery structure 401 using the grasping fixture 441. The protruding portions 414bA1, 414aA1 are provided so that the grasping fixture 441 can grasp the protruding portions 414bA, 414aA1 more stably and securely.

In this state, as shown in FIG. 22, a peeling tool 442 having a claw 441a is used to insert the tip of the claw 442a of the peeling tool 442 into a gap formed by the negative electrode side recess 414bB of the negative electrode side frame member 414b, and the part of the negative electrode current collector 423 exposed in the gap is grasped by the claw 442a. The presence of the negative electrode side recess 414bB allows the claw 442a to be easily inserted into the negative electrode side recess 414bB, thereby easily and surely grasping the region near the edge of the exposed negative electrode current collector 423 by the claw 442a. Then, as shown in FIG. 22, the negative electrode current collector 423 is peeled off from the negative electrode side frame member 423. A plurality of claws 442a hold the negative electrode current collector 423 along the edge of one short side, so that a uniform force is applied to the negative electrode current collector 423 over the entire width of the short edge. The negative electrode current collector 423 is thus peeled off without leaving any residue.

When peeling off the negative electrode current collector 423, the negative electrode side frame member 414b may be heated using a heater or the like to make peeling easier. The heating temperature is set to about 200° C., for example.

Subsequently, as in FIG. 16, the negative electrode active material layer 424 exposed from the negative electrode side frame member 414b is recovered (step S13).

Subsequently, the positive electrode current collector 321 is peeled off and removed from the single battery structure 301 (step S14).

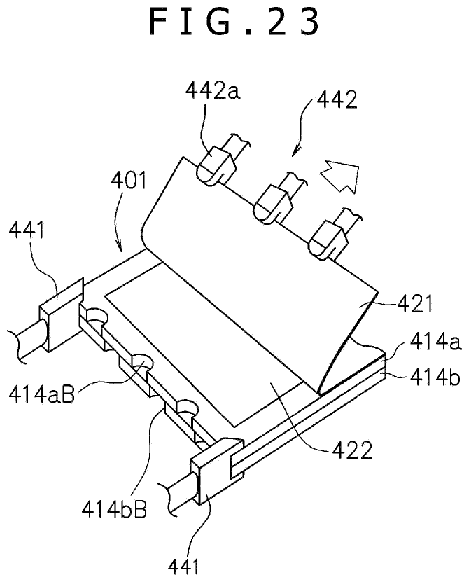

More specifically, as shown in FIG. 23, the single battery structure 301 is fixed by grasping the protruding portions 414aA, 414bA of the single battery structure 301 using the grasping fixture 441. The protruding portions 414aA, 414bA are provided so that the grasping fixture 341 can grasp the protruding portions 414aA, 414bA more stably and securely.

In this state, as shown in FIG. 23, a peeling tool 442 having a claw 441a is used to insert the tip of the claw 442a of the peeling tool 442 into a gap formed by the positive electrode side recess 414aB of the positive electrode side frame member 414b, and the part of the positive electrode current collector 423 exposed in the gap is grasped by the claw 442a. The presence of the positive electrode side recess 414aB allows the claw 442a to be easily inserted into the positive electrode side recess 414aB, thereby easily and surely grasping the region near the edge of the exposed positive electrode current collector 421 by the claw 442a. Then, as shown in FIG. 23, the positive electrode current collector 421 is peeled off from the positive electrode side frame member 421. A plurality of claws 442a hold the positive electrode current collector 421 along the edge of one short side, so that a uniform force is applied to the positive electrode current collector 421 over the entire width of the short edge. The positive electrode current collector 421 is thus peeled off without leaving any residue.

When peeling off the negative electrode current collector 421, the positive electrode side frame member 414a may be heated using a heater or the like to make peeling easier. The heating temperature is set to about 200° C., for example.

Subsequently, as in FIG. 18, the negative electrode active material layer 424 exposed from the negative electrode side frame member 414a is recovered (step S15).

(Segregation Process)

As in FIG. 14 of the first embodiment, the recovered active materials (the negative electrode active material in the negative electrode active material layer 422 and the negative electrode active material in the negative electrode active material layer 424 negative electrode active material) are segregated.

As explained above, according to this embodiment, the frame members 414 (the positive electrode side frame member 414a and the negative electrode side frame member 414b) have the recesses (the negative electrode side recess 414bB, 414bB) that exposes the edges of the current collectors (the positive electrode current collector 421 and the negative electrode current collector 423). This makes it easy to grasp the edges of the current collector when peeling off the current collector and allows easy peeling. After the current collector is peeled off, the active material layers (the negative electrode active material layer 424 and the positive electrode active material layer 422) can be recovered reliably, so that the active material layers can be easily recovered in the recycling process.

In one embodiment, an electronic component that detects the state of a single battery may be disposed inside a single battery (single battery structure). For example, the electronic component that detects the state of the single battery may be disposed inside the frame member, or the electronic component that detects the state of the single battery may be disposed inside a part of the protruding portion of the frame member. Otherwise, the electronic component detecting the state of the single battery may be disposed between the positive electrode current collector and the negative electrode current collector in the single battery (e.g., between the peripheral edge of the positive electrode current collector and the peripheral edge of the negative electrode current collector).

The electronic components are depicted assuming amplifiers, ICs, etc. as electronic components, and chip resistors as other electronic components for controlling current and/or voltage. The types of electronic components to be mounted on a wiring substrate are not limited to these. When a module combining multiple electronic components is installed in a frame member, the module that includes a wiring substrate is also included in the case where a wiring substrate is installed in the frame member.

In this embodiment, it is preferable that a wiring substrate is provided within, for example, the negative electrode side frame member of the single battery, and the electronic components are mounted on the wiring substrate. It is also preferred that other electronic components for controlling the current and/or voltage supplied to the electronic components are mounted on the wiring substrate. The wiring substrate is provided in the negative electrode side frame member and mounting electronic components on the wiring substrate, so that various measurements and controls can be performed by combining multiple functions.

Although the preferred current and/or voltage differs for each electronic component specification, the current and/or voltage supplied directly from a single battery may not be compatible with the electronic component specifications. Other electronic components is provided by being mounted on the wiring substrate to control the current and/or voltage supplied to the electronic components in such cases, so that a variety of electronic components can be used.

The electronic component is an electronic component for detecting conditions within a single battery. For example, a sensor is preferable that measures temperature, voltage, current or acoustic emission at a predetermined location within a single battery. It is also preferred that the electronic component is capable of wirelessly outputting a signal indicating the state inside the single battery to the outside of the single battery. When the electronic component is a sensor, the state inside the single battery can be detected, and when the electronic component is capable of wireless output, the signal indicating the detected state can be output wirelessly and the measurement results can be received outside the battery, allowing the state inside the single battery to be known without dismantling the single battery.

By measuring the temperature, voltage or current in a single battery, it is possible to detect a local temperature rise, current rise, voltage drop, etc. caused by a short circuit or other defect in a part of the single battery. Further, by measuring acoustic emissions, it is possible to detect whether damage or deformation has occurred within a single battery.

Passive and active elements can be used as electronic components. As these elements, capacitors, inductors, resistors, transistors, diodes, ICs, LSIs, or any other elements can be used. In a case of electronic components that can output wirelessly, the component may be antennas, filters, amplifiers, oscillators, etc. The component may also be wireless communication modules in which these components are modularized, or they can be sensor-integrated modules.

It is also possible to have a switch that switches between detecting and not detecting the state inside a single battery by an electronic component located in the frame member, and to switch the switch to detect the state inside a single battery 1 when an external signal is given. By ensuring that detection of the state inside a single battery is performed only when an external signal is given, power consumption by the electronic components can be reduced. In the above configuration, the electronic component should be equipped with an antenna element for receiving signals from the outside. The signals from the outside include signals commanding the detection of the state within a single battery, signals commanding the detection of the state within a single battery to stop, and the like.

The electronic components are preferably electrically connected to the positive electrode current collector and the negative electrode current collector so that they can receive power supply from the single battery. When the electronic components are electrically connected to the positive electrode current collector and the negative electrode current collector, they can be activated by receiving power supply from the single battery. This can be a simple configuration because there is no need to provide a power supply and wiring to operate the electronic components.

When a resin current collector is used as a current collector in this embodiment, for example, the positive electrode current collector and the electrodes of the electronic component can be brought into contact, and the positive electrode current collector can be heated to soften the resin, thereby directly bonding the negative electrode current collector and the electronic component. Specifically, by using a resin current collector, electrical connection can be made without using other bonding materials such as solder between the current collector and electronic components.

For example, the external electrodes of the electronic components in the positive electrode side frame member may be in contact with the positive electrode current collector and the negative electrode current collector. In this case, the electronic component is electrically connected to the positive electrode current collector and the negative electrode current collector.

Further, it is preferable that the frame member has a through-hole for disposing electronic components, the electronic components are disposed in the through-hole, and that the thickness of the frame member and the height of the electronic components are approximately the same. When the electronic component is disposed in the through hole, it is easy to dispose the electronic component in the frame member, and by making the thickness of the frame member and the height of the electronic component approximately the same, the electronic component can be brought into contact with the positive electrode current collector and the negative electrode current collector, and the electronic component can be electrically connected to the positive electrode current collector and the negative electrode current collector. For example, a through-hole may be provided in the positive electrode side frame member and the electronic component may be disposed in the through-hole. The thickness of the frame member and the height of the electronic components may be approximately the same.

In a lithium-ion secondary battery, electronic components should be disposed at multiple locations in a frame member on the periphery of the single battery 1, respectively, to enable individual detection of conditions at different locations in the single battery.

As the area viewed from the top of a single battery becomes larger, i.e., the larger the battery capacity, the easier it is for variations in characteristics to occur within the single battery, so that it is particularly effective to have electronic components disposed at a plurality of locations within the frame member on the periphery of the single battery, respectively, to individually detect indicators of the state within the single battery. For example, the area viewed from the top of the single battery is preferably 600 cm² or more. As for the relationship between the area of the single battery viewed from the top and the number of electronic components, it is preferable to dispose one to two electronic components per 100 cm² of the area viewed from the top of the single battery.

As explained above, in one embodiment, by installing electronic components within, for example, the protruding portion of the frame member of a single battery, it is possible to detect the state inside the single battery and, as a result, to identify the location of a defect in the single battery. By placing the electronic component inside the frame member, it is not necessary to provide space outside the single battery to place the electronic component, thereby saving space for the entire lithium-ion secondary battery.

As described above, a lithium ion battery according to one embodiment of the present invention is a lithium-ion battery having an electrode composition, a current collector, and a separator, the electrode composition layer containing coated active material in which at least a part of the surface of an electrode active material is coated with a coating material containing polymer compound, the lithium-ion battery comprising a frame member for fixing a peripheral portion of the separator that is placed between a pair of current collectors, wherein the frame member has a protruding portion that protrudes outward in a plane direction from an edge of the current collector when viewing the single battery from the laminating direction, the frame member or the protruding portion has a pressure releasing portion that communicates inside and outside of the frame member when the pressure inside the frame member increases above a certain level.

In an embodiment described above, the end edge of the frame member or the portion of the protruding portion where the end edge of the current collector is located may be formed with a recess to expose the end edge of the current collector.

In one embodiment above, the electrode composition layer may include a non-bound body consisting of the coated active materials that are in a mutually unbonded state.

In one embodiment above, the current collector is a resin current collector including a resin and a conductive filler; and a lamination structure composed of the resin current collector and the electrode composition layer may be more flexible than a lamination structure composed of a metal current collector and an electrode composition layer containing a binder resin.

In an embodiment described above, the recess may has a shape in which the portion of the frame member on the current collector side is cut off.

In one embodiment of the above, in the lithium-ion battery of the present invention, in a case the recess is formed in the area of the protruding portion that is located at the edge of the current collector, the recess may be formed along the edge of the current collector.

In one embodiment above, the protruding portion may protrude from the long side of the current collector outward in a plane direction and toward a direction substantially perpendicular to the direction of extension of the long side.

In an embodiment described above, the frame member may be provided with a first frame member disposed on the side of one of the current collectors and a second frame member disposed on the side of the other current collector, and the recess may be provided with a first recess formed in the first frame member and a second recess formed in the second frame member.

In an embodiment described above, in a case where the recess is formed on the edge of the frame member, the recess may be penetratingly formed in the laminating direction of the frame member.

In one embodiment above, the frame member is provided with a first frame member disposed on the side of one of the current collectors and a second frame member disposed on the side of the other current collector, the recess is provided with a first recess formed in the first frame member and a second recess formed in the second frame member, the first recess penetrates in the thickness direction of the first frame member, the second recess penetrates in the thickness direction of the second frame member, and the first recess and the second recess may be provided at the different positions in the laminating direction.

In an embodiment described above, an electronic component for detecting the state of a single battery may be disposed inside the frame member.

In an embodiment described above, an electronic component for detecting the state of a single battery may be disposed inside the protruding portion.

A method for manufacturing a regenerated electrode active material according to one embodiment of the present invention includes the steps of: preparing the lithium-ion battery described above; grasping the protruding portion of the frame member; and peeling the current collector using the edge of the frame member or the area of the protruding portion where the edge of the current collector is located, which is exposed in the recess, while the protruding portion is grasped.

The manufacturing method for an embodiment described above may further include the steps of, after one of the current collectors is peeled, spraying a dissolving solution on one of the electrode composition layer so as to remove one of the electrode composition layers dissolved in the liquid by flowing the layer away.

The manufacturing method of one embodiment above may further include the step of, after the other current collectors is peeled, removing the other electrode composition layer by scraping the layer off.

The manufacturing method according to one embodiment above may further include the steps of: preparing the frame member; and assembling the single battery using the frame member.

The manufacturing method according to one embodiment above may further include the step of forming the recess in the prepared frame member.

In the manufacturing method for the above one embodiment, the frame member may be provided with a first frame member disposed on the side of one of the current collectors and a second frame member disposed on the side of the other current collector; in the step of forming the recess, a first recess penetrating in the thickness direction of the first frame member and a second recess penetrates in the thickness direction of the second frame member may be formed; and in the step of assembling the single battery, the first frame member and the second frame member may be assembled to the single battery so that positional deviation in the laminating direction occurs between the first recess and the second recess.

[Third Aspect]

The third aspect of lithium-ion battery module will be described below.

Conventionally, an assembled battery consisting of multiple lithium-ion battery single batterys laminated together has been used as power sources for power-supply portable electronic devices such as electric and hybrid electric vehicles. When recharging such batteries, it is necessary to manage the recharging so that there are no single batteries that are overcharged.

As such a charging device, it is described in Patent Literature 3 that each single battery and a data processing unit are electrically connected via conductors, and the voltage between the terminals of each single battery is controlled for charging by data processing.

However, in the configuration as shown in Patent Literature 3, the single batteries are electrically connected to each other by metal wiring (voltage detection wires). In this configuration, the number of wirings increases in accordance with the number of laminated single batteries, resulting in the problem of increased weight. In addition, as the number of wirings connected to each single battery increases, more space is required for wiring. Further, if each single battery is electrically connected to the wiring, there is a risk of shorts between the single batteries and the wiring process becomes complicated.

For the purpose of solving such problems, the inventors of the present invention have found a configuration in which each of the single batteries included in an assembled battery is equipped with a light emitting portion that measures the characteristics of the single battery and outputs optical signals based on the characteristics of the single battery, and a light receiving portion that collectively receives optical signals output from each of the single batteries. According to the configuration found by the inventors, the optical signals received by the light-receiving portion are analyzed (e.g., analyzed by a data processing unit (battery state analyzer) connected to the light-receiving portion), thereby eliminating the risk of short circuits between the single batteries and the complicated works for wiring process that has been conventionally required when connecting to each of the single batteries with a wire, which makes it possible to manage the state of the assembled battery.

However, in the configuration found by the inventors, optical signals are output from each of the plurality of single batteries included in the assembled battery, and the optical signals of each of these batteries are received together at the light-receiving portion, so that the plurality of optical signals received at the light-receiving portion may collide.

The purpose of the third aspect is to provide a lithium-ion battery module that avoids collision of optical signals output from a plurality of single batteries without connecting electrical wiring between the plurality of single batteries.

As a result of earnest examination based on the above findings, the inventors have conceived of a series of diligent examinations and have arrived at the various aspects of the present invention shown below.

A lithium-ion battery module, comprising:
a single battery unit having a single battery, a light emitting portion that measures the characteristics of the single battery and outputs an optical signal based on the characteristics, a single battery light receiving portion that receives the optical signal, and a control portion that controls the light emission of the light emitting portion;
an assembled battery consisting of a plurality of single battery units laminated together;
a light receiving portion that receives the optical signal output from the assembled battery; and
an outer package that accommodates the assembled battery,
wherein the control portion controls the lithium-ion battery module not to output the optical signal from the light emitting portion for a predetermined period of time when the optical signal from another single battery unit among a plurality of the single battery units is received at the single battery light receiving portion.

According to the third aspect, collision of signals output from each single battery of the lithium-ion battery module can be avoided.

### First Embodiment

The first embodiment will be described below with reference to the accompanying drawings.

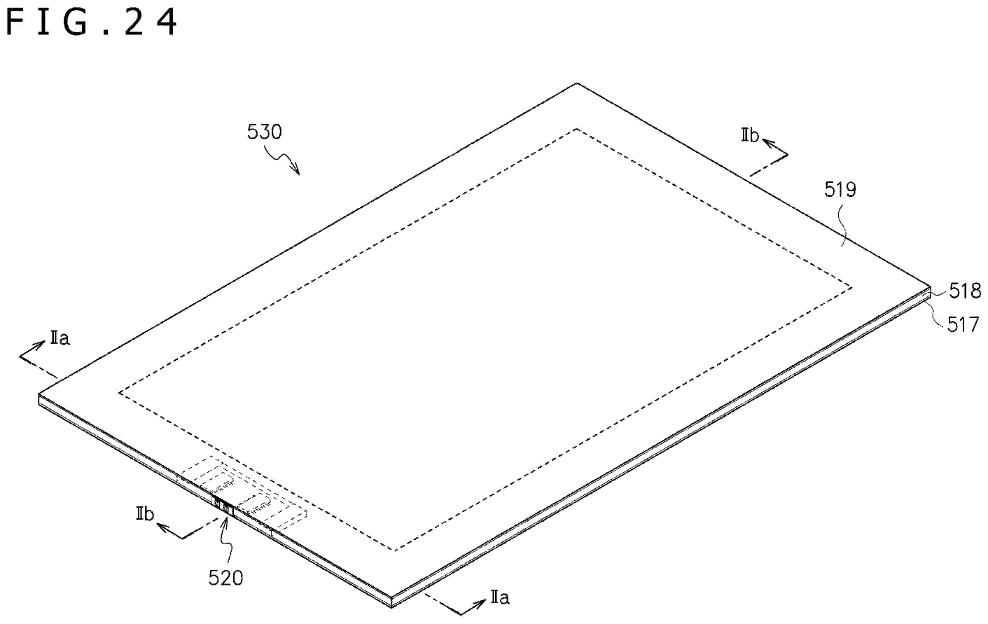

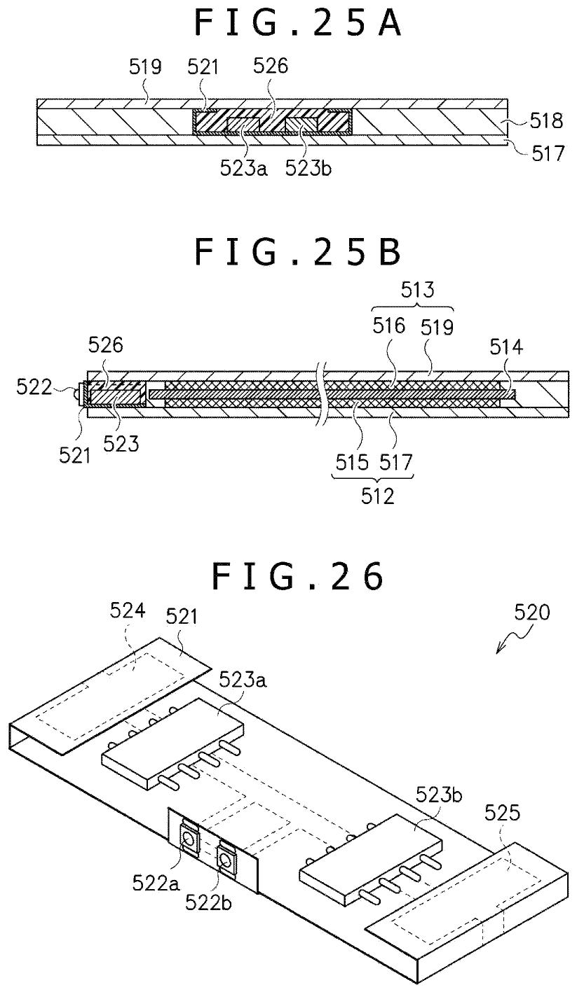

FIG. 24 is a diagram of a single battery comprising a lithium-ion battery module according to the first embodiment of the present invention. FIG. 25A is a IIa-IIa cross sectional view, and FIG. 25B is a IIb-IIb cross sectional view. The lithium-ion battery module 501 includes

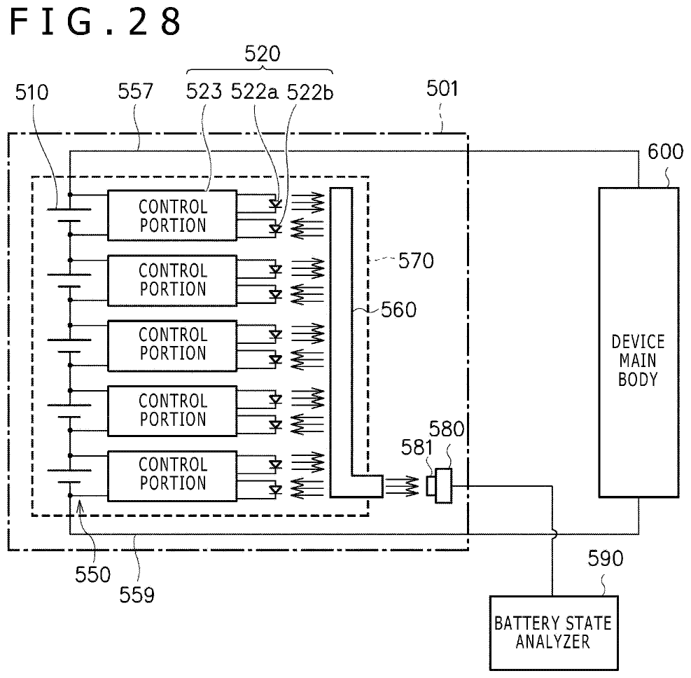

an assembled battery 550 (see FIG. 27) consisting of a plurality of laminated single battery units 530 that is composed of a single battery 510, and a light emitting/receiving portion 520 having a light emitting portion 522a and a single battery light receiving portion 522b, an assembled battery light receiving portion 580 (see FIG. 28), an optical waveguide 560 (see FIG. 27), and an outer package 570 (see FIG. 27).

As shown in FIG. 25B, the single battery 510 consists of a positive electrode current collector 517, a positive electrode active material layer 515, a separator 514, a negative electrode active material layer 516, and a negative electrode current collector 519 that are laminated in this order from the bottom. The single battery 510 consists of a positive electrode 512 with the positive electrode active material layer 515 formed on the surface of a positive electrode current collector 517 having a substantially rectangular flat shape, and a negative electrode 51 similarly with the negative electrode active material layer 513 formed on the surface of a negative electrode current collector 519 having a substantially rectangular flat shape, which are laminated via a separator 514 similarly having a rectangular flat shape. Furthermore, the single battery 510 of this embodiment has the light emitting/receiving portion 520 described below that is embedded in the frame member 518 so as to be exposed on the side of the frame member 518.

The single battery 510 has the annular frame member 518 between the positive electrode current collector 517 and the negative electrode current collector 519. The frame member 518 fixes the periphery of the separator 514 between the positive electrode current collector 517 and the negative electrode current collector 519, and the positive electrode active material layer 515, the separator 514, and also seals the negative electrode active material layer 514 and the negative electrode active material layer 516.

The positive electrode current collector 517 and the negative electrode current collector 519 are disposed so as to face each other at a predetermined interval by the frame member 518. Further, the separator 514, the positive electrode active material layer 515 and the negative electrode active material layer 516 are disposed to face each other at a predetermined interval by the frame member 518.

The interval between the positive electrode current collector 517 and the separator 514 is adjusted in accordance with the thickness of the active material layer of the lithium ion battery. The interval between the negative electrode current collector 519 and the separator 514 is also adjusted in accordance with the thickness of the active material layer of the lithium ion battery. The positional relationship among the positive electrode collector 517, the negative electrode collector 519 and the separator 514 are determined so that the required interval is obtained.

The positive electrode active material layer 515 contains a positive electrode active material. The positive electrode active material is preferably a coated positive electrode active material coated with a conductive auxiliary agent and a coating resin. As a result, since the positive electrode active material is coated with the coating resin, the volume change of the electrode is alleviated and the expansion of the electrode is suppressed.

The negative electrode active material layer 516 contains a negative electrode active material. The negative electrode active material may be a coated negative electrode active material coated with a conductive auxiliary agent and a coating resin similar to the coated positive electrode active material described above. As conductive auxiliary agents and coating resins, the same conductive auxiliary agents and coating resins as the above-mentioned coated positive electrode active material can be suitably used.

The negative electrode active material layer 516 may also contain a conductive auxiliary agent in addition to the conductive auxiliary agent contained in the coated negative electrode active material. As the conductive auxiliary agent, the same conductive auxiliary agent as that contained in the coated positive electrode active material described above can be suitably used.

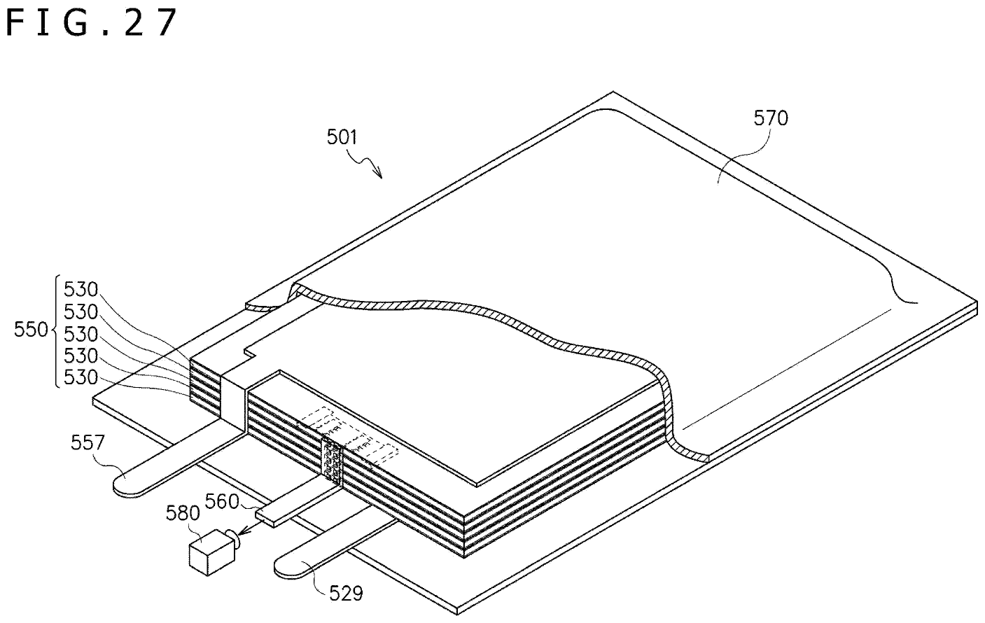

Next, FIG. 26 is a perspective view of the light emitting portion and the single battery light receiving portion constituting the lithium-ion battery module of the first embodiment of the present invention. The light emitting/receiving portion 520 of this embodiment consists of a wiring substrate 521, a light emitting portion 522a, a single battery light receiving portion 522b, and control portions 523 a, 523b (hereinafter also referred to as 523). As shown in FIG. 25B, the light emitting/receiving portion 520 is disposed between the positive electrode current collector 517 and the negative electrode current collector 519 so as to be exposed at the end of the single battery 510. The light emitting/receiving portion 520 is also formed by bending both ends of the wiring substrate 521 inward and covering the space formed by them with the insulating resin 526. Further, the light emitting/receiving portion 520 is provided with a measurement terminals 524 at the end of the wiring substrate 521 and a measurement terminal 525 at a position opposite to the measurement terminal 524. This allows the light emitting/receiving portion 520 to measure the voltage across the positive electrode current collector 517 and the negative electrode current collector 519 in the single battery 510.

The control portion 523 performs control in the light emitting/receiving portion 520, such as emitting optical signals and controlling the pattern of optical signals. The control portion 523 also performs the conversion into an optical signal pattern based on the voltage of the single battery, and transfers this to the light emitting portion 522a. Furthermore, the control portion 523 controls the light emitting portion 522a not to output optical signals for a predetermined period of time when the single battery light receiving portion 522b receives an optical signal from the other single battery unit in the plurality of single battery units 530. This enables a single optical signal from the plurality of single battery units 530 and prevents the signals from being mixed. Further, the control portion 523 uses any semiconductor, such as an IC or LSI, for example. In this embodiment, the control portions 523A and 523B are implemented, however, this is not limited to this, but one, or even three or more is available.

The light emitting unit 522a measures the voltage of the single battery 510 and outputs an optical signal with an optical signal pattern corresponding to the measured voltage. This allows the voltage of the single battery to be detected and output wirelessly outside the single battery in the form of an optical signal. Examples of voltage-dependent optical signal patterns include a pattern in which the higher the voltage measured by the voltage measurement terminal, the narrower the pulse interval and a pattern in which the light emitting time per unit of time becomes longer, etc.

The single battery light receiving portion 522B receives the optical signal from the other single battery unit 530 among the plurality of single battery units 530 that is reflected by one of the members of the lithium-ion battery module 501. As a result, the control portion 523 controls the optical signal output from the light emitting unit 522a not to be output, so that the optical signal output from the plurality of single battery units 530 can be combined in one. Further, in this embodiment, the one of the members described above is, but not limited to, the optical waveguide 560, for example, and a member that reflects optical signals may be used in the outer package or inside thereof.

The optical signal pattern output to the outside of the single battery 510 is received by the battery receiving portion 80 (see FIG. 27) that is provided outside of the single battery and insulated from the single battery. The assembled battery light receiving portion 580 is provided with a light receiving element 581. The optical signal received by the light receiving element 581 is inversely converted into an electrical signal. This allows an electrical signal indicating the state in the single battery 510 to be obtained. Further, as will be described later, when the optical signal from the other single battery unit 530 among the plurality of single battery units 530 is received by the single battery light receiving portion 522b, the single battery unit 530 that received the light is controlled so as not to output the optical signal from the light emitting unit 522a for a predetermined period of time. This allows the assembled battery light receiving portion 580 to receive only one optical signal, thereby avoiding receiving a plurality of mixed optical signals. In this embodiment, the light emitting portion 522a is, for example, a light emitting diode, and the single battery light receiving portion 522 b and the assembled battery light receiving portion 580 are phototransistors or the like.

The light emitting/receiving portion 520 is electrically connected to the negative electrode collector 519 and the positive electrode collector 517 of the assembled single battery 510, and can receive power supplied from the lithium-ion battery. If the light emitting/receiving portion 520 is electrically connected to the negative electrode current collector 519 and the positive electrode current collector 517, the light emitting/receiving portion 522a can emit light by receiving power supplied from the lithium ion battery. The configuration can be simplified because there is no need to provide a power supply and wiring to make the light emitting portion 522a emit light.

When the light emitting/receiving portion 520 is electrically connected to the negative electrode collector 519 and the positive electrode collector 517, the negative electrode collector 519 and the positive electrode collector 517 are resin collectors, and it is preferable that the negative electrode collector 519 and the positive electrode collector 517 are directly coupled and electrically connected to the electrodes of the light emitting/receiving portion 520.

When using a resin current collector, the resin current collector can be directly bonded to the electrodes of the light emitting portion by bringing the resin current collector into contact with the electrodes of the light emitting portion and heating the resin current collector to soften the resin. Further, other conductive bonding materials such as anisotropic conductive film (ACF) (any other bonding agent, such as conductive paste and conductive adhesive, etc., can be applied as long as it has a function that provides conductivity or a function to bond without heating or with a very short heating time) can also interpose between the current collector and the light emitting/receiving portion 520 to make an electrical connection therebetween.

FIG. 27 is a schematic partially cutaway view of a lithium-ion battery module according to the first embodiment of the present invention. The lithium-ion battery module 501 is provided with an assembled battery 550, an optical waveguide 560, an outer package 570, and a light receiving portion 580 of the assembled battery.

The assembled battery 550 consists of a plurality of laminated single battery units 530. In this embodiment, five single battery units 30 are laminated, and the adjacent single battery units 530 are laminated so that the top surface of the negative electrode current collector 519 and the bottom surface of the positive electrode current collector 519 are adjacent to each other. In this case, the single battery units 530 are connected in series. On the outer surface of the assembled battery 550, the light emitting/receiving portions 520 are disposed in a row, and an optical waveguide 560 is provided to cover this row of light emitting/receiving portions 520.

The optical waveguide 560 introduces the output optical signal from the light emitting portion 522a. More specifically, the optical waveguides 560 are smaller in number than that of the light emitting units 522a (optical signals from the light emitting units), and are the optical paths that commonly transmit optical signals output from each of the plurality of single battery units 530. The assembled battery light receiving portion 580 is installed at one end of the optical waveguide 560 (signal output portion), and the assembled battery light receiving portion 580 is configured to receive a plurality of optical signals transmitted through the common optical path the signals.

The assembled battery 550 and the assembled battery light receiving portion 589 are electrically isolated from each other. This allows the state of the assembled batteries to be managed without having to connect each of the single batteries to each other via metal wiring as in the conventional configuration. Further, the assembled battery light receiving portion 580 receives the optical signals generated from the plurality of single battery units 530. Further, the light receiving portion 580 is electrically connected to the battery condition analyzer 590 described below, and the battery condition analyzer 590 analyzes the received optical signals so that the characteristics of the single batteries included in the assembled battery are analyzed.

The outer package 570 accommodates the assembled battery 550 and the optical waveguide 560. In this embodiment, a polymer-metal composite film or the like, but not limited to this, is used as a component of the outer package 570. Furthermore, the outer package 570 accommodates the optical waveguide 560 so that one end of the optical waveguide 560 is outside the outer package 570. As a result, the optical signals from each single battery unit 530 of the assembled battery 550 are introduced into the optical waveguide 560, and thus the optical signal can be introduced into the assembled battery light receiving portion 580.

A conductive sheet is provided over the negative electrode collector 519 on the top surface of the assembled battery 550, and a part of the conductive sheet 570 is drawn out from the outer package 559 to form the lead wiring. Further, a conductive sheet is provided on the positive electrode current collector 517 on the bottom surface of the assembled battery 550, and a part of the conductive sheet is drawn out from the outer package 570 to form the lead wiring 557. The conductive sheet is not limited to any conductive material as long as the material thereof has conductivity, and metallic materials such as copper, aluminum, titanium, stainless steel, nickel, and alloys thereof, as well as materials described as resin current collectors can be selected and used as appropriate.

Thus, the assembled battery light receiving portion 580 and the light emitting portion 522a are not electrically connected, and information is transmitted between the assembled battery light receiving portion 580 and the light emitting portion 522a by means of optical signals.

The reference will be made as to the control of interference caused by the plurality of optical signals that may arise in the lithium-ion battery module of the first embodiment of the present invention, where the light receiving portion and the assembled battery are not electrically connected.

FIG. 28 is a block diagram showing the circuit configuration of the lithium-ion battery module of the first embodiment of the present invention. The lithium-ion battery module 501 is connected to a device main body 600 via the lead wiring 559 and the lead wiring 557 described above. The device main body 600 operates by the power supplied from the assembled battery 550. In the lithium-ion battery module, as to each of which has a light emitting portion 522a of the plurality of single battery units 530, characteristics of the single battery 510 are measured and an optical signal is generated based on the characteristics, and the optical signal is introduced into the optical waveguide 560. The optical signal derived from the optical waveguide 560 is transmitted to the single battery light receiving portion 522b and the assembled battery light receiving portions 522b, which are opposite to the optical waveguide 560. In the lithium-ion battery module of this embodiment whose details will be described below, the control portions 523a, 523b controls the assembled battery light receiving portion 522b upon receiving the optical signal reflected in the optical waveguide 560 not to output the optical signal from the light emitting unit 522 of the single battery unit 530. This allows the assembled battery light receiving portion 580 to receive the optical signal output in the optical waveguide from one single battery unit. Thus, triggered by the reception of the optical signal from the single battery light receiving portion 522b, the control portions 523a, 523b controls the output of the optical signal, thereby avoiding collisions of optical signals output from the plurality of single battery units 530.

The pair battery receiving portion 580 sends the received optical signal to the electrically connected battery condition analyzer 590, and the optical signal is analyzed by the battery state analyzer 590. The battery condition analyzer 590 then analyzes the temperature, voltage, and other characteristics of the single battery of the single battery unit that generated the optical signal. This allows the temperature and voltage of the single battery to be determined.

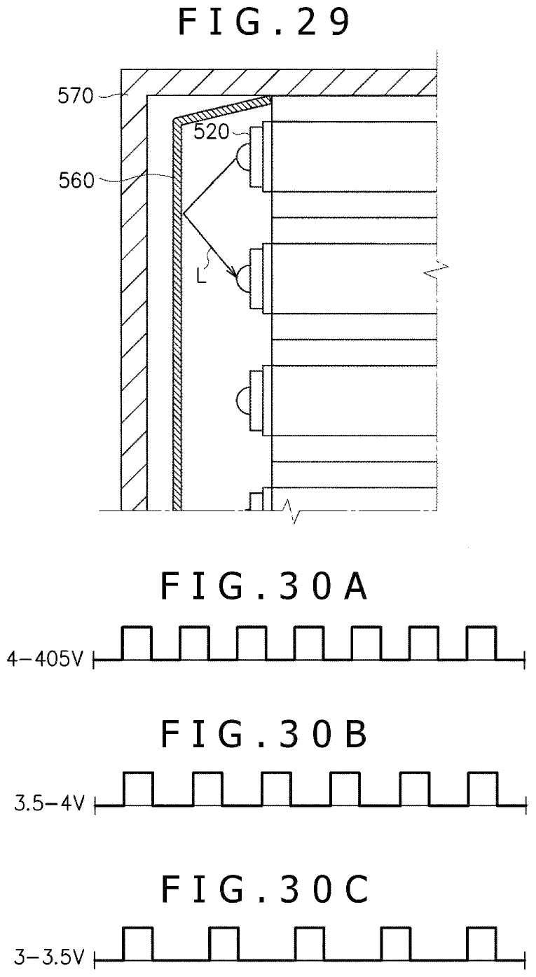

Next, the operation in a case where the optical signals generated from the light emitting portion 522a of the plurality of single battery units 530 are received by the other single battery unit 530 is explained using FIG. 29. FIG. 29 is a schematic enlarged cross sectional view of a lithium-ion battery module according to the first embodiment of the present invention. A plurality of single battery units 530 are laminated, and the optical waveguide 560 is disposed to cover the light emitting/receiving portions 520 of each single battery unit 530, and the outer package 570 accommodates these elements.

An optical signal L output from the light emitting portion 522a of each single battery unit 530 is reflected by the optical waveguide 560 and received by the single battery light receiving portion 522b of the other single battery unit 530. The other single battery unit 530 then prevents the optical signal from being generated from the light emitting portion 522a for a predetermined period of time. This allows the optical signal generated from the light emitting unit 522a to be received by the assembled battery light receiving unit 522b without colliding with the optical signal from the other light emitting unit.

The predetermined period of time may be the time during which the light emitting portion 522a of the single battery unit 530 can receive the optical signal pattern at the assembled battery light receiving portion 580 to receive the optical signal pattern, as described below.

When the optical signal L generated from the light emitting portion 522a of the single battery unit in question is received by the single battery light receiving portion 522b of the single battery unit in question, the optical signal is recognized, and thus the optical signal is generated by the light emitting portion 522a of the single battery unit in question.

The optical signal patterns that arise based on the characteristics of the single batteries in the single battery unit 530 will be described.

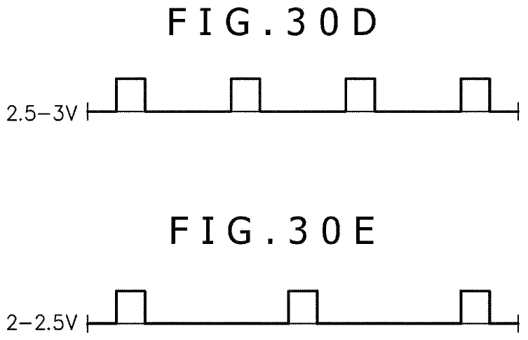

FIGS. 30A to 30E are schematic diagrams showing the optical signal patterns for different voltages of single batteries, respectively. To obtain these optical signal patterns, the light emitting portion is provided with a voltage measurement terminal to measure the voltage between the positive electrode current collector and the negative current collector of the single battery, and a temperature measurement terminal to measure the temperature of the single battery. The control portion controls the light emitting portion to emit light with a predetermined optical signal pattern.

FIGS. 30A to 30E are schematic diagrams showing examples of optical signal patterns at different single battery voltages, respectively. FIGS. 30A to 30E show the optical signal patterns in a case of single battery voltages of 4 to 4.5V, 3.5 to 4V, 3 to 3.5V, 2.5 to 3V, and 2 to 2.5V, respectively. These patterns are pulse patterns in which the signal is repeatedly turned on and off within a predetermined time period, and the predetermined time period is set to 100 s (100 seconds). The predetermined period of time is not particularly limited, and can be set to any time.

In these examples, the optical signal pattern is the same for one emission time, and the higher the voltage, the greater the number of emission ON/OFF repetitions. However, any optical signal pattern can be used as long as the voltage corresponds to the shape of the optical signal pattern. For example, the optical signal pattern may have the same number of emission ON/OFF, and longer emission time per emission with higher voltage. In addition, it is not necessary that all the light emission durations within a given time are the same. Although the shape of the optical signal pattern is made to differ in voltage increments of 0.5 V, the voltage increment width is not particularly limited.

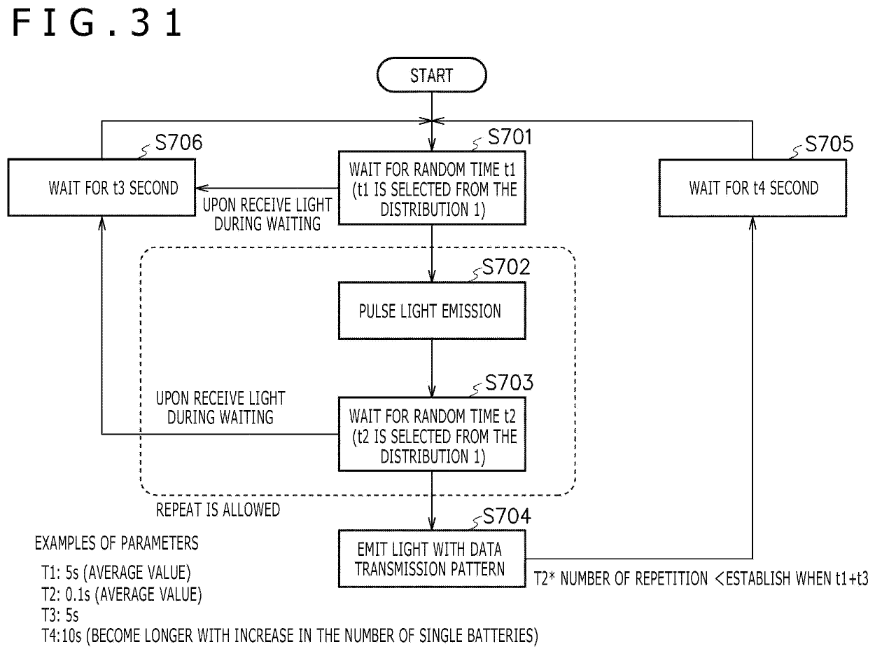

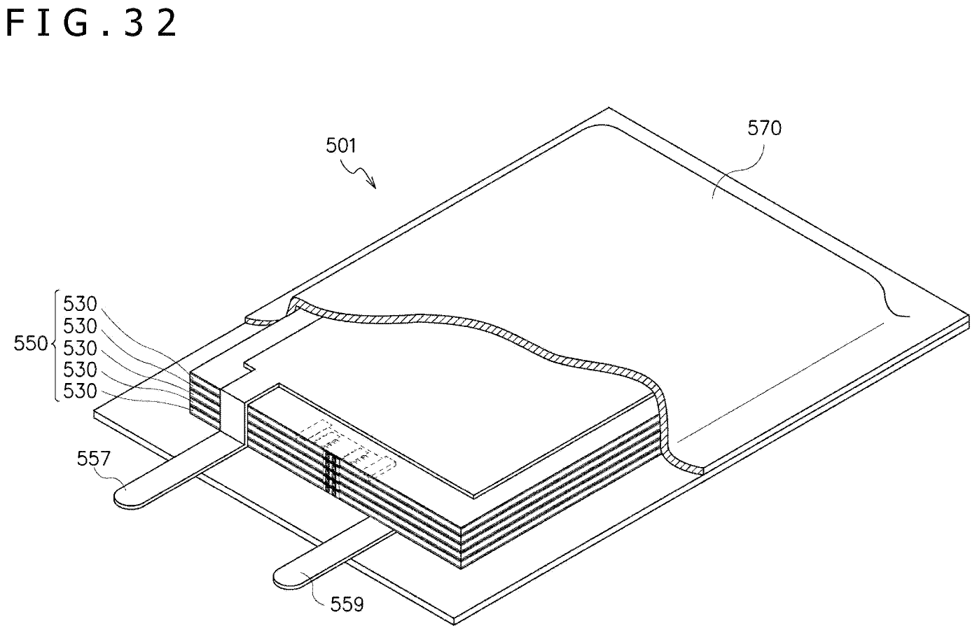

A control method for information transfer between Each of the single battery units 530 of the lithium-ion battery module 501 and the assembled battery light receiving portions 580 according to the first embodiment of the present invention will be described using FIG. 31.

When the control for information transmission is initiated in the lithium-ion battery module 501, first, the light emitting unit 522a each of the single battery units 530 waits without emitting light for a predetermined cycle t1 chosen at random, for example, 5 seconds (S701). The cycle t1 is selected from the distribution 1 stored in the control portion 523. Then, when the optical signal of another single battery unit 530 is received during the waiting time, the single battery light receiving portion 522b of the single battery unit 530 is controlled by the control portion 523 to stand by, so that it waits for another t3 seconds, e.g., 5 seconds (S706), and the process returns to step S701. On the other hand, after waiting in step S701, each single battery unit 530 emits a pulse signal from the light emitting portion 22a (S702) and waits for a random period t2, for example, 0.1 second, without emitting light (S703). The period t2 is selected from the distribution 2 stored in the control portion 523 in the same manner as period t1. At this time, in the single battery unit 530 out of the single battery units 530 that emitted light first, when the single battery light receiving portion 522b received the optical signal from the single battery unit 530 that emitted light first, the light emitting portion 522a ceases to produce an optical signal for a predetermined period of time. Specifically, when the optical signal reflected in the optical waveguide 560 is received by the single battery light receiving portion 522b, no optical signal is generated from the light emitting unit 522a for a predetermined time. Then, at step S702, the pulse signal of the single battery unit 30 that emits light first is transmitted to the single battery light receiving portion 522b of each single battery unit 530 and the assembled battery light receiving portion 580. Steps S702 and S703 may be repeated N times, and may be repeated until t1+t3>N is established. Then, after waiting at step S703, the single battery unit 530 that emits light sends an optical signal of the data transmission pattern described above in FIGS. 30A to 30E (S704). Then, the single battery unit 530 that emitted light first waits for t4 seconds, e.g., 10 seconds, upon finishing the transmission of the optical signal (S705), and returns to step S701. At step S705, the waiting time t4 seconds is set to 10 seconds, however, the waiting time t4 may be made longer as the number of laminated single battery units 530 increases.

### Second Embodiment

Next, the lithium-ion battery module of the second embodiment of the present invention will be described. In the first embodiment, the configuration has been exemplified along with the basic structure of the lithium-ion battery module of the first embodiment in which the optical signal generated from the light emitting portion 522a of the single battery unit is introduced into the optical waveguide and received by the light receiving portion of the assembled battery. However, the configuration without an optical waveguide can be employed as long as it is in line with the technical concept of the present invention. The like parts as in the first embodiment are omitted from the explanation.

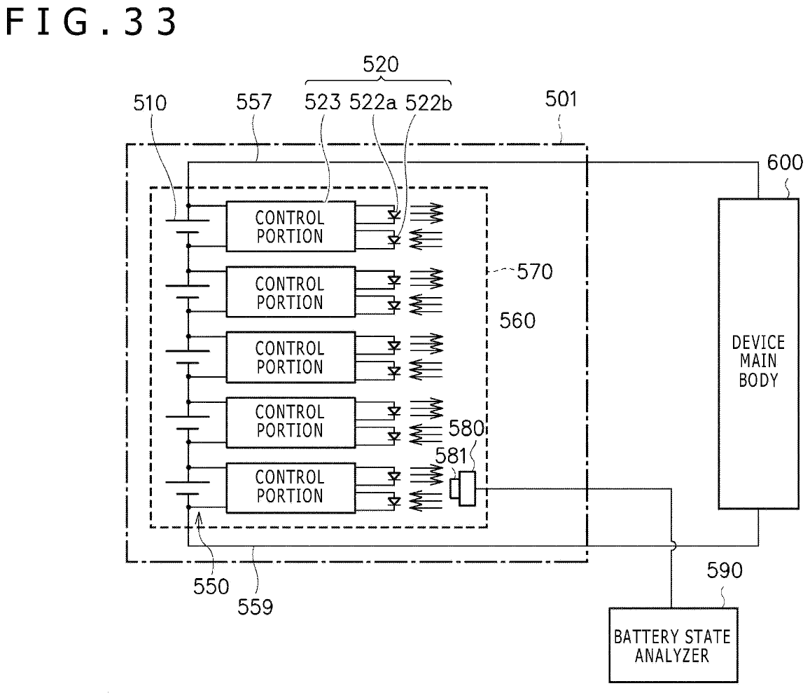

FIG. 32 is a partially cutaway view schematically showing the lithium-ion battery module of the second embodiment of the present invention. FIG. 33 is a block diagram showing the circuit configuration of the lithium-ion battery module of the second embodiment of the present invention. In the lithium-ion battery module 501 of the second embodiment, the assembled battery 550 and the battery light receiving portion 580 are accommodated in the outer package 570.

The battery state analyzer 590 is electrically connected to the assembled battery light receiving portion 580, for example, via wiring. The battery state analyzer 590 is located outside the outer package 570, and the electrical signals from the assembled battery light receiving portion 580 are output to the battery state analyzer 590.

The control portions 523a, 523b control the light emitting portion 522a not to output the optical signal for a predetermined time when the reflected optical signal L is received by the single battery light receiving portion 522b. As a result, the assembled battery light receiving portion 580 can receives the optical signal output from one single battery unit 530 inside the outer packaging.

The outer package 570 has a member that reflects the optical signal output from the light emitting portion 522a. For example, the outer package 570 of this embodiment uses a metal can case, polymer-metal composite film, or the like as a member that reflects the optical signal. As a result, the outer package 570 can reflect the optical signal L output from the light emitting portion 522a.

In this embodiment, the outer package 570 is made of a member that reflects optical signals, but the material is not limited to this, and a member that reflects optical signals can be provided between the outer package 570 and the assembled battery.

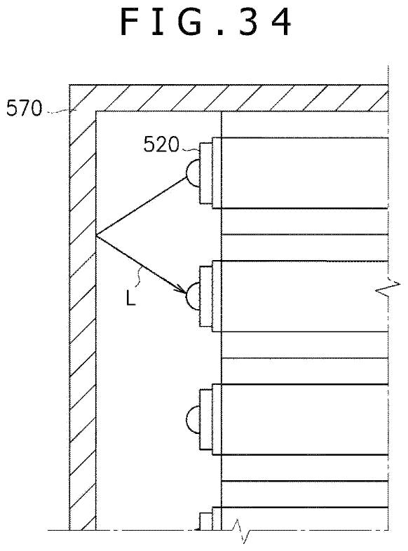

Next, an example of the operation of the optical signal output from the light emitting unit 522a of the plurality of single battery units 530 when it is received by another single battery will be explained using FIG. 34. FIG. 34 is a schematic enlarged cross sectional view of a lithium-ion battery module according to the second embodiment of the present invention. A plurality of single battery units 530 are laminated, and the light emitting/receiving portion 530 of each single battery unit 530 20 and the light receiving portion 580 of the assembled battery unit are accommodated in the outer package 570.

The light emitting portion 522a of each single battery unit 530 outputs an optical signal L toward the outer package 570. The optical signal L is then reflected by the outer package 570 and received by the single battery light receiving portion 522b of the other single battery unit 530. At this time, the control portions 523a, 522b of the other single battery unit 530 do not output the optical signal L output from the light emitting unit 522a for a predetermined period of time. Accordingly, the optical signal L output from the light emitting portion 522a of one single battery unit 530 can be received by the battery receiving unit 580 without colliding with the optical signal L from the light emitting portion 522a of another single battery unit 530.

The predetermined time in this embodiment may be any time as long as for the optical signal pattern of the optical signal L of the light emitting portion 522a of the single battery unit 530 can be received by the assembled battery light receiving portion 580.

Each time the light is received by the single battery light receiving portion 522b of another single battery unit 530, a predetermined waiting time is randomly selected from a certain distribution. Even if the optical signal L generated from the light receiving portion 522b of the single battery unit in question is received by the single battery light receiving portion 522b of the single battery unit in question, the light emitting portion 522a of the single battery unit in question generates an optical signal because the optical signal is recognized.

As described above, by controlling the light emitting/receiving portions of each single battery unit, the collision of signals of each single battery unit 530 can be avoided and the assembled battery light receiving portion 580 can receive optical signals without connecting electrical wiring between the plurality of single batteries.

In the embodiment described above, a configuration in which the optical waveguide covers the light emitting/receiving portions of each single battery unit was employed, however, other configurations, such as a configuration in which the optical waveguide does not cover the light emitting/receiving portions of each single battery unit and the optical signal is reflected by the outer package and the reflected optical signal is introduced into the light path, are also acceptable.

As described above, a lithium-ion battery module in this embodiment consists of a plurality of single battery units having a single battery, a light emitting portion that measures the characteristics of the single battery and outputs an optical signal based on the characteristics, a single battery light receiving portion that receives the optical signal, and a control portion that controls the light emission of the light emitting portion; an assembled battery consisting of a plurality of single battery units laminated together; a light receiving portion that receives the optical signal output from the assembled battery; and an outer package that accommodates the assembled battery, wherein the control portion controls the lithium-ion battery module not to output the optical signal from the light emitting portion for a predetermined period of time when the optical signal from another single battery unit among a plurality of the single battery units is received at the single battery light receiving portion.

In an aspect described above, the single battery light receiving portion may receive an optical signal from another single battery unit among the plurality of single battery units that is reflected off one of the lithium-ion battery modules.

In an aspect described above, an optical waveguide into which the optical signal output from the light emitting unit is introduced is further provided, and the control portion may control the light emitting portion not to output the optical signal for a predetermined period of time when the single battery light receiving portion receives the optical signal reflected within the optical waveguide.

In an aspect described above, the optical waveguide is an optical path for commonly transmitting optical signals output from each of the plurality of cell units, and the plurality of optical signals transmitted via the common optical path are signals of the common optical path may be received by the assembled battery light receiving portion installed in the output portion.

In an aspect described above, the outer package may have a member that reflects the optical signal, and the control portion may control the light emitting portion not to output the optical signal for a predetermined period of time when the single battery light receiving portion receives the optical signal reflected inside the outer package.

In an aspect described above, the assembled battery and the battery receiving portion may be electrically isolated from each other.

In an aspect described above, the light emitting portion may measure the voltage of the single battery and output an optical signal pattern in accordance with the measured voltage.

In an aspect described above, the assembled battery light receiving portion may be electrically connected to an analyzer that analyzes the optical signals received from the light emitting portion.

As described above, a control method for a lithium-ion battery module is a method for controlling the lithium-ion battery module comprising an assembled battery comprising a plurality of laminated single battery units having a single battery, a light emitting portion that measures the characteristics of the single battery and outputs an optical signal based on the characteristics, and a single battery light receiving portion that receives the optical signal, wherein each of the single battery unit includes a non-light emitting step in which the light emitting portion does not output the optical signal for a predetermined time when the light receiving portion receives the optical signal from the other single battery unit; a light emitting step of emitting light so as to output the optical signal from the light emitting portion of the single cell unit that does not receive the optical signal from the other single cell unit in the non-light emitting step; a light receiving step of receiving the optical signal in the assembled battery light receiving portion; and a determination step of determining whether or not a plurality of the optical signals have been received in the assembled battery light-receiving portion.

In the control method according to an embodiment described above, a control method for a lithium ion battery module further comprising an exterior body having a member that reflects an optical signal output from the light emitting section, wherein the cell light receiving section receives the optical signal reflected in the exterior body. The method may further include a non-light emitting step of not outputting the optical signal from the light emitting unit for a predetermined time.

In the control method according to an embodiment described above, a control method for a lithium ion battery module may further comprises a non-emission step of, when the light receiving portion of the single battery receives the optical signal reflected in the outer package, not outputting the optical signal from the light emitting unit for a predetermined period of time when the single battery light receiving portion receives the optical signal reflected in the outer package may be further included.

The embodiments described above are for facilitating understanding of the present invention, and are not intended to limit and interpret the present invention. Flowcharts, sequences, elements included in the embodiments, their arrangement, materials, conditions, shapes, sizes, and the like described in the embodiments are not limited to those illustrated and can be changed as appropriate. In addition, it is possible to replace some or all of the components shown in different embodiments or add components and combine them.

### INDUSTRIAL APPLICABILITY

In the battery cell of the present invention, the inside and outside of the frame member are communicated when the pressure inside the frame member increases beyond a certain level by the pressure-relieving portion. Therefore; damage to the battery cell can be prevented.

1. A battery cell, comprising
an electrode composition containing electrode active material particles
a frame member placed annularly so as to surround the electrode composition; and
a base material for closing openings of the frame member from both sides in the thickness direction,
wherein the frame member has a pressure releasing portion for communicating inside and outside of the frame member when the pressure inside the frame member increases above a certain level.

2. The battery cell according to claim 1, wherein the pressure releasing portion is provided in a certain area of the frame member, and is a fragile portion that is more fragile than areas of the frame member except the certain area.

3. The battery cell according to claim 2, wherein the fragile portion is a thinned portion that is formed thinner than the other area of the frame member.

4. The battery cell according to claim 2, wherein the fragile portion is a low melting point portion that has a lower melting point than that of the other area of the frame member.

5. The battery cell according to claim 1, wherein the electrode composition consists of a negative electrode composition layer and a negative electrode composition layer that are laminated via a separator; and
the base material is an electrode current collector.

6. A lithium-ion battery having an electrode composition, a current collector, and a separator, the electrode composition layer containing coated active material in which at least a part of the surface of an electrode active material is coated with a coating material containing polymer compound, the lithium-ion battery comprising:
a frame member for fixing a peripheral portion of the separator that is placed between a pair of current collectors,
wherein the frame member has a protruding portion that protrudes outward in a plane direction from an edge of the current collector when viewing the single battery from the laminating direction,
the frame member or the protruding portion has a pressure releasing portion that communicates inside and outside of the frame member when the pressure inside the frame member increases above a certain level.

7. The lithium-ion battery according to claim 6, wherein a recess that exposes the edge of the current collector is formed in the frame member or an area of the protruding portion where the edge of the current collector is located.

8. The lithium-ion battery according to claim 7, wherein the electrode composition layer includes a non-bound body consisting of the coated active materials that are in a mutually unbonded state.

9. The lithium-ion battery according to claim 7, wherein the current collector is a resin current collector including a resin and a conductive filler, and
a lamination structure composed of the resin current collector and the electrode composition layer is more flexible than a lamination structure composed of a metal current collector and an electrode composition layer containing a binder resin.

10. The lithium-ion battery according to claim 7, wherein:
the recess has a shape in which the portion of the frame member on the current collector side is cut off.

11. The lithium-ion battery according to claim 7, wherein:
in a case the recess is formed in the area of the protruding portion that is located at the edge of the current collector,
the recess is formed along the edge of the current collector.

12. The lithium-ion battery according to claim 7, wherein:
the protruding portion protrudes from the long side of the current collector outward in a plane direction and toward a direction substantially perpendicular to the direction of extension of the long side.

13. The lithium-ion battery according to claim 7, wherein:
the frame member is provided with a first frame member disposed on the side of one of the current collectors and a second frame member disposed on the side of the other current collector, and
the recess is provided with a first recess formed in the first frame member and a second recess formed in the second frame member.

14. The lithium-ion battery according to claim 7, wherein:
in a case where the recess is formed on the edge of the frame member, the recess is penetratingly formed in the laminating direction of the frame member.

15. The lithium-ion battery according to claim 14, wherein:
the frame member is provided with a first frame member disposed on the side of one of the current collectors and a second frame member disposed on the side of the other current collector,
the recess is provided with a first recess formed in the first frame member and a second recess formed in the second frame member,
the first recess penetrates in the thickness direction of the first frame member,
the second recess penetrates in the thickness direction of the second frame member, and
the first recess and the second recess are provided at the different positions in the laminating direction.

16. The lithium-ion battery according to claim 7, wherein:
an electronic component for detecting the state of a single battery is disposed inside the frame member.

17. The lithium-ion battery according to claim 7, wherein:
an electronic component for detecting the state of a single battery is disposed inside the protruding portion.

18-23. (canceled)
